(19) United States
(12) Patent Application Publication
(10) Pub. No.: US 2016/0055594 A1
(43) Pub. Date: Feb. 25, 2016

(54) METHOD OF USING BUILDING PERMITS TO IDENTIFY UNDERINSURED PROPERTIES

(71) Applicant: BuildFax, Inc., Asheville, NC (US)

(72) Inventor: Joseph Tierney Masters Emison, Asheville, NC (US)

(21) Appl. No.: 14/930,874

(22) Filed: Nov. 3, 2015

Related U.S. Application Data
(63) Continuation-in-part of application No. 14/185,215, filed on Feb. 20, 2014.

(51) Int. Cl. G06Q 40/08; G06F 17/30

(52) U.S. Cl. CPC G06Q 40/08; G06F 17/30241; G06F 17/30539

(57) ABSTRACT

Computer-implemented methods and computer systems for identifying whether there exists building permit information associated with a structure, or for estimating underinsurance of condition of a structure are provided. The computer implemented methods include acquiring construction information on a plurality of structures in computer-readable form and converting the construction information into a standardized database. The construction information may include building permit data including one or more of the number of building permits within a particular time frame, building permit age, building permit category, and job cost. Further, the computer implemented methods may include estimating underinsurance or condition of a target structure based on the construction information.

### CROSS-REFERENCE TO RELATED APPLICATIONS

The present application is a Continuation-in-Part (CIP) of U.S. patent application Ser. No. 14/185,215, filed Feb. 20, 2014, the disclosure of which is incorporated herein by reference in its entirety.

### BACKGROUND OF THE INVENTION

1. Field of the Invention

The present disclosure relates to methods and systems of using building permits to identify underinsured properties of properties with a condition that may negatively affect insurance coverage. Such systems and methods can be used in the homeowners insurance industry. In embodiments, the present disclosure relates to a computer-implemented method for estimating underinsurance or condition of a structure based on building permits, which can be used to determine whether inspection of the structure before issuing an insurance policy is recommended to enable an insurance policy that is commensurate with the condition of and/or improvements to the property.

2. Description of Related Art

In the insurance industry, the loss ratio is the ratio of the claims settled by an insurance company over premiums earned. Losses in the form of claims are added to adjustment expenses and then divided by total earned premiums. The loss ratio is one indicator of how an insurance company is performing financially. Thus, higher loss ratios may indicate that an insurance company may need to improve its underinsurance models to guard against future possible insurance payouts.

In the homeowners insurance industry, the insurance to value ratio is the ratio of the amount of insurance purchased to the replacement value of the property. Most property policies require that the property be insured to a proportion of the replacement cost, such as 80%, or loss payments will be reduced accordingly. This is referred to as the coinsurance penalty. Thus, it is important that insurance companies have an accurate assessment of the value of the homes of policy holders; otherwise if they are underinsured the policy holder may be responsible for covering the difference.

Home upgrades and improvements have a significant impact on both the value and condition of a property, and thus impact an insurer's assessment of a property as well as the insurance-to-value ratio. However, homeowners rarely contact their insurance companies after an addition or significant remodel and carriers have not had any effective way to find out which homes have been significantly improved. Insurance carriers underwrite policies and then, as long as they continue to renew each year, generally ignore them and assume that nothing has changed about them (still in the same amount of repair, no remodels, etc). However, carriers are worried about the risks of the above assumptions/workflow. Homes are going into disrepair. Homeowners are increasing the cost of replacing their homes through remodels and additions, and this means (a) carriers are not getting paid the proper amount to cover the home, yet (b) carriers may still be on the hook for the increased amount if a jury finds that the carrier really should have done some work to figure out the increased amount. The following exemplary quotes show common concerns that insurance carriers are having with industry-standard practices:

“I have 80% of my book that I haven't looked at in nearly 10 years, and I know I am exposing my company to risk.”

“We re-inspect on a cycle with a low-cost re-inspection program that is too expensive for most properties, but not in-depth enough to catch looming problems.”

“We try to inspect every policy upon renewal, but it's just not working—we had a lot of inspections that weren't finding serious condition issues that showed up after claims, and essentially no inspection found additions or remodels.”

Thus, lack of physical inspection of properties typically results in significant risk of loss assumed by an insurance carrier. Further, current physical inspection procedures are often inadequate to catch significant problems in home maintenance, whether they are reinspected on a fixed schedule or upon renewal.

One attempt by others to address this issue is to provide a “Property FICO” score. Insurance regulators, however, are often quite suspicious of arbitrary scores that are not broken down into specific, actionable, obviously-changeable factors. This is why credit score—even though it is quite predictive of auto loss—cannot be used for rating or eligibility in quite a few states in the context of property insurance. Alternatively, as the present disclosure provides, data relating to “permit age” or other “permit intelligence” can be used for rating or eligibility by insurance carriers. Carriers can get most of the benefit by rating/discounting/surcharging on “most recent remodel” or by moving year built forward. Evaluating underinsurance based on a “most recent remodel” analysis, contrary to existing techniques, is not an arbitrary score—and it does not require a proprietary solution. For example, evidence of “most recent remodel” is available through other means than the present disclosure offers by using permit data, such as by physical inspection of the property by an appraiser.

Despite efforts in this technological area, such as those described in U.S. Pat. Nos. 7,966,203, 8,027,850, 8,244,563, and U.S. Patent Application Nos. 20120331002 and 20130262029, which are all incorporated by reference herein in their entireties, there is a need in the art for more accurate methods of assessing the value and condition of a property.

### SUMMARY OF THE INVENTION

One aspect of embodiments of this disclosure is the use of permit information as a proxy for property condition. Such permit information used in the analysis can include one or more of the type, age, and cost of work associated with a permit. For example, a 30-year old property with no permit information would have a lower property condition score than a 30-year old property located in the same area with several recent permits relating to major systems, especially for which the permitted work was costly. The term “property” in the context of this disclosure can include any real estate, such as residential, agricultural, or commercial and can be used interchangeably with structure, building, improvement, house, garage, barn, office building, driveway, parking lot, parking garage, home, recreational facility, stadium, tennis court, swimming pool, outdoor or indoor track, temporary or permanent structures, and the like.

Particular embodiments of this disclosure include a system for determining whether to inspect a real estate property in conjunction with issuing an insurance policy associated with the property, the system comprising:
a non-transitory computer memory for storing data indicative of:
(i) an expected permit history for the real estate property, wherein the expected permit history includes expected maintenance events for maintaining the real estate property in an insurable condition,
(ii) events associated with actual maintenance of the property, and
(iii) events associated with actual improvements made to the property,
a processor in communication with the memory, wherein the processor is configured for:
comparing the expected permit history with the events associated with actual maintenance of the property to estimate physical condition of the property or if the property is underinsured; and
determining whether to inspect the property based at least in part on a result of the comparing and the events associated with actual improvements made.

Embodiments include data-driven methods of identifying properties to be inspected before issuing or renewing an insurance policy, the method comprising: searching a database of permit data associated with a plurality of properties; determining whether permit data for a target property is present in the database; if the permit data for the target property is present, extracting improvement or maintenance data from the permit data associated with the target property; using a computer processor and the presence of or lack of permit data, improvement data, or maintenance data associated with the target property to estimate physical condition of the target property or if the target property is underinsured; assigning a condition or underinsurance score to the target property; and identifying based on the score whether inspection of the target property is warranted before issuing or renewing the insurance policy for the target property.

Embodiments of the present disclosure also provide for computer-implemented methods and computer systems for identifying the construction information associated with a structure, or estimating the condition or underinsurance of a structure. The computer implemented methods comprise acquiring building permit information on a plurality of structures in computer-readable form and converting the construction information into a standardized database. The computer-implemented methods may include analyzing the data in the database through one or more of modeling, determining a coverage area, and text mining, querying the database to identify construction information on a target structure, and outputting a report on the identified construction information on the target structure. The computer-implemented methods may also include receiving appraisal data on the conditions of a subset of the plurality of structures, and/or receiving insurance data related to a subset of the plurality of structures, and determining a relationship between the construction information and appraisal data or insurance data. Further, the computer implemented methods may include estimating the condition or underinsurance of a target structure based on the construction information identified for the target structure and the determined relationships for the subset of structures or properties.

In one embodiment of this disclosure, a computer-implemented method for estimating the condition of a target structure is provided, the method comprising identifying a target structure for which an estimated condition is desired, receiving construction information related to a plurality of structures in computer-readable form, receiving appraisal data on the conditions of a subset of the plurality of structures, converting the construction information and appraisal data into a standardized database format, determining a relationship between the appraisal data and building permit data for the subset of structures, identifying the construction information associated with the target structure, and estimating the condition of the target structure based on the construction information associated with the target structure and the relationship between the appraisal data and construction information for the subset of structures or properties.

In another embodiment of this disclosure, a computer-implemented method for determining the underinsurance of a target structure is provided, the method comprising identifying a target structure for which an estimate of underinsurance is desired, receiving construction information related to a plurality of structures in computer-readable form, receiving insurance data related to a subset of the plurality of structures, the insurance data comprising total losses paid by an insurance company in the form of claims and collected premiums, converting the construction information and insurance data into a standardized database format, determining a loss ratio for the subset of the plurality of structures based on the whether a permit is present, determining a relationship between the presence of a permit and the loss ratio, identifying the construction information associated with the target structure, and estimating the underinsurance of the target structure based on the identified construction information associated with the target structure and the relationship between the presence of a permit and the loss ratio of the subset of structures or properties.

In another embodiment of this disclosure, a computer-implemented method for identifying the building permit information associated with a target structure is provided, the method comprising acquiring building permit information on a plurality of structures in computer readable form, converting the building permit information to a standardized database format, analyzing the data in the database through one or more of modeling, determining a coverage area, and text mining, querying the database to identify building permit information on a target structure, and outputting a report on the identified building permit information on the target structure or property.

In another embodiment of this disclosure, a method of determining the property condition for a structure is provided, the method comprising providing, in a database, computer-readable data comprising a national data set of construction information for a plurality of structures, a data set of loss records for a subset of the plurality of structures, and a data set of appraisal records for a subset of the plurality of structures, querying the computer readable data to identify the construction information for a target structure, and processing the computer-readable data with a processor to determine one or more criteria of property condition based on the national data set of construction information, the data set of loss records, and the data set of appraisal records, and compare the identified construction information for the target structure with the one or more criteria of property condition to determine a property condition of the target structure.

In any embodiment of this disclosure, the construction information may be building permit data including one or more of number of building permits within a particular time frame, building permit age, building permit category, and job cost.

Any embodiment of this disclosure may further comprise mining of the building permit data for key words to determine one or more categories of building permit data, wherein the condition or underinsurance of the target structure is estimated based on the one or more categories of building permit data associated with the target structure or property.

Any embodiment of this disclosure may further comprise analyzing the building permit data to determine one or more coverage areas of one or more building departments serving one or more of the plurality of structures, wherein the condition or underinsurance of the target structure is estimated based on a coverage area associated with the target structure or property.

Any embodiment of this disclosure may further comprise modeling the building permit data, wherein the condition or underinsurance of the target structure is estimated based on modeled building permit data associated with the target structure or property.

In any embodiment of this disclosure, identifying the building permit data associated with the target structure may comprise querying the standardized database for the address of the target structure or property.

In any embodiment of this disclosure, identifying the building permit data associated with the target structure may further comprise generating a report on the building permit data associated with the target structure or property.

In any embodiment of this disclosure, building permit data associated with the target structure may include any one or more of the following, for example, a number of building permits, building permit age, building permit category and job cost.

In any embodiment of this disclosure, the condition of the target structure may be estimated based on an algorithm, statistical method, formula, and/or computational routine.

In any embodiment of this disclosure, the relationship between the conditions of the subset of the plurality of structures and building permit data may be a positive correlation between the percentage of building permits held by the subset of the plurality of structures and the conditions of the subset of structures or properties.

In embodiments, the insurance data related to a subset of the plurality of structures may comprise the type of loss claimed for the structures or properties.

In any embodiment of this disclosure, the type of loss claimed for the subset of structures may be selected from the group consisting of fire, water, and wind/hail.

In any embodiment of this disclosure, the underinsurance of the target structure may be estimated based on an algorithm, statistical method, formula, or computational routine.

In any embodiment of this disclosure, the relationship between the presence of a permit and the loss ratios of the subset of structures may be such that the presence of a permit is associated with reduced loss ratios.

In any embodiment of this disclosure, text mining may comprise mining of the building permit data for key words to determine one or more categories of building permit data.

In any embodiment of this disclosure, coverage areas of one or more building departments serving one or more of the plurality of structures are determined.

In any embodiment of this disclosure, the building permit data associated with the target structure may include the number of building permits, building permit age, building permit category and/or job cost.

In any embodiment of this disclosure, the building permit category may be one or more selected from the group consisting of building, electrical, mechanical, plumbing, HVAC, pool, roof, kitchen, living room, family room, bathroom, bedroom, office, hallway, basement, garage, repair and replace, addition, and remodel and other. The building permit category may also be any other category available to a skilled artisan not specifically recited herein.

### BRIEF DESCRIPTION OF THE DRAWINGS

The accompanying drawings illustrate certain aspects of embodiments of the present invention described in this disclosure, and should not be used to limit or define this disclosure. Together with the written description the drawings explain certain principles of this invention.

FIG. 1 is a flowchart illustrating an exemplary embodiment of a computer-implemented method according to this disclosure.

FIG. 2 is a screenshot of an XML output according to an embodiment of this disclosure.

FIG. 3 is a screenshot of an HTML output according to an embodiment of this disclosure.

FIG. 4 is a screenshot of an HTML output of a permit record for a Building permit according to an embodiment of this disclosure.

FIG. 5 is a screenshot of an HTML output of a permit record for a Plumbing permit according to an embodiment of this disclosure.

FIG. 6 is a screenshot an HTML output of a permit record summary according to an embodiment of this disclosure.

FIG. 7 is a screenshot of an HTML output of a permit record summary of major systems according to an embodiment of this disclosure.

FIG. 8 is a screenshot of an HTML output of types of permits that may contribute to characterizing a property as having a Highly Improved Condition (typically associated with underinsurance) or a Low Maintained Condition (typically associated with a high condition risk) according to an embodiment of this disclosure.

FIG. 9 is a graph showing the relationship between permit presence and appraiser condition ratings according to an embodiment of this disclosure.

FIG. 10 is a table showing the statistical correlation (R²) between permits of each age category with condition ratings C1-C4 and C2-C4 according to an embodiment of this disclosure.

FIG. 11 is a flowchart illustrating an embodiment of a computer-implemented method for estimating the condition of a target structure according to an embodiment of this disclosure.

FIG. 12 is a table showing the Uniform Appraisal Dataset building condition codes and their criteria.

FIG. 13 is a table showing loss analyses according to property age and whether the property had a permit (yes, no, unknown) over the last 10 years and according to fire, water, and other damage (non-wind/hail damage) according to an embodiment of this disclosure.

FIG. 14 is a table showing loss analyses according to property age and permit category according to an embodiment of this disclosure.

FIG. 15 is a table showing loss analyses according to property age and job cost according to an embodiment of this disclosure.

FIG. 16 is a flowchart illustrating an embodiment of a computer-implemented method for determining underinsurance of a target structure according to an embodiment of this disclosure.

FIG. 17 is a schematic diagram showing a targeted underinsurance and condition detection embodiment of the present invention.

FIG. 18 is a graph showing a distribution of underinsurance and condition categories according to the inventor's national database of properties.

FIGS. 19A and 19B are photographs showing examples of major changes to a property which typically result in underinsurance, with FIG. 19A showing a new swimming pool and FIG. 19B showing an addition.

FIGS. 20A and 20B are photographs showing examples of properties with a low condition factor and a high condition factor, with FIG. 20A showing a highly maintained property (low condition factor) and FIG. 20B showing a poorly maintained property (high condition factor).

FIG. 21 is a schematic diagram showing a computer system according to an embodiment of this disclosure.

### DETAILED DESCRIPTION OF VARIOUS EMBODIMENTS OF THE INVENTION

Reference will now be made in detail to various exemplary embodiments of this invention described in this disclosure. It is to be understood that the following discussion of exemplary embodiments is not intended as a limitation on this invention. Rather, the following discussion is provided to give the reader a more detailed understanding of certain aspects and features of this invention.

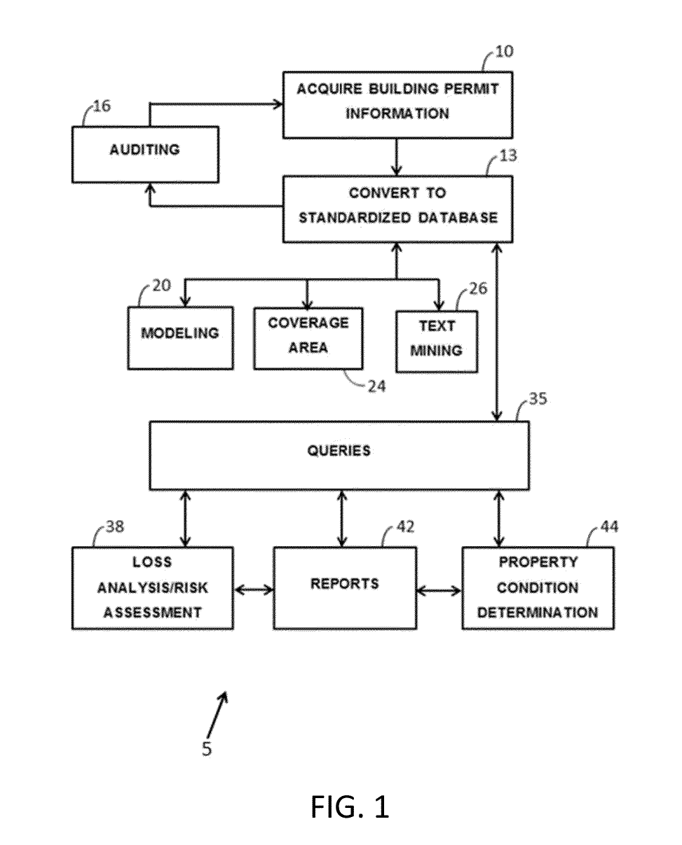

FIG. 1 shows an exemplary embodiment of a computer-implemented method 5 of the present disclosure. Construction information including but not limited to building permit data is first acquired 10, and then the obtained data is converted 13 into a standardized format and stored in a database. One or more selections of the data in the database may then be audited 16 by comparing the converted data to the source data. After the data is converted 13 into a standardized database it may be modeled 20 and coverage areas based on the construction information may be determined 24. The data may also be mined 26, for example using text mining, to determine various parameters and categories of building permit information. Typically after these steps, queries of the database may be performed 35, and based on the queries 35 the data may be analyzed to determine the insurance loss ratio 38 associated with specific categories of permit data. Reports 42 in a variety of formats may be produced based on the queries 35, as well as a property condition determination 44 for any target property. Both the property condition determination 44 and loss analysis 38 may issue into reports 42 as well. These steps will be elaborated further below. While an exemplary embodiment arranges these steps as shown in FIG. 1, it will be understood that other variations such as a different order of steps, or elimination, substitution, or addition of steps, also fall within this disclosure.

### Construction Information

The computer-implemented method of the present disclosure, in embodiments, comprises obtaining construction information on a plurality of structures, including but not limited to building permit information, warranty records, and building material and/or equipment purchases or deliveries, from a variety of sources. Sources of construction information include contractors, permit inspectors, building material or equipment suppliers or deliverers, and local Building Departments, as well as any other government agencies that will supply construction information through a public records request. These are just examples and the construction information may come from any suitable source. As used herein, “construction information” and “construction-related records” refers to any record referring to any update, improvement, maintenance, remodel, repair, replacement, addition, change, or similar construction or work to a structure of any subcomponent, component or system of the structure since the time after completion of original construction of the structure. “Construction information” related to a structure may include such records related to subcomponents of a structure including but not limited to foundation, frame, drywall, flooring, windows, siding, and roof; information related to individual rooms including but not limited to garage, basement, kitchen, living room, family room, bathroom, and bedroom, and information related to systems including but not limited to plumbing, electrical, mechanical, and HVAC. “Construction information” may include building permit records but may also include records on purchases, deliveries, or warranties related to building materials or equipment, or any other record that would indicate work or construction on a structure occurring after the original construction of the structure. Illustrative examples of such records include a building permit authorizing work on the siding of a structure, a delivery receipt of a $5000 order of flooring material from Home Depot, a $2500 window purchase order from Lowes, or a 5 year warranty on installment of a new furnace. However, “construction information” does not include any information on any aspect of the structure that relates to the original construction of the structure, such as the cost, purchase, delivery, or warranty of original materials or equipment of the structure at the time that it was first built. The construction information may be any source of information which would serve as a record of any construction or work that has happened at a specified structure or property since completion of the original construction of the structure. Further, the construction information may relate to commercial and residential structures or properties, as well as government-financed structures or properties, or may be limited to commercial, residential, or government-financed structures or properties or any combination thereof. The construction information may comprise millions, tens of millions, or hundreds or millions of records, including 100 million, 150 million, 200 million, 250 million, 300 million, 350 million, 400 million, 450 million, 500 million, or more. Further, the construction information may comprise a national set of records, such as those originated in the United States, or optionally other countries such as Canada or Great Britain, or may comprise a regional set of records such as those originating in North America or the European Union.

As used herein, the term “property condition” refers to the condition of the structure itself or improvements or additions to the structure (including a room, pool, or shed) and not the actual land (such as a yard) that is allocated as part of the property of the structure.

In another embodiment, data related to physical inspections of one or more of a plurality of structures is obtained. The physical inspection data may include features related to a structure and their conditions, whether the features passed or failed the inspection, replacement cost estimates, date of the inspection, and the like. The physical inspection data may be obtained in a variety of electronic file formats outlined above. In another embodiment, both construction information and physical inspection data is obtained. In another embodiment, no physical inspection data is obtained, and only construction information is obtained. In yet another embodiment, no construction information is obtained and only physical inspection data is obtained.

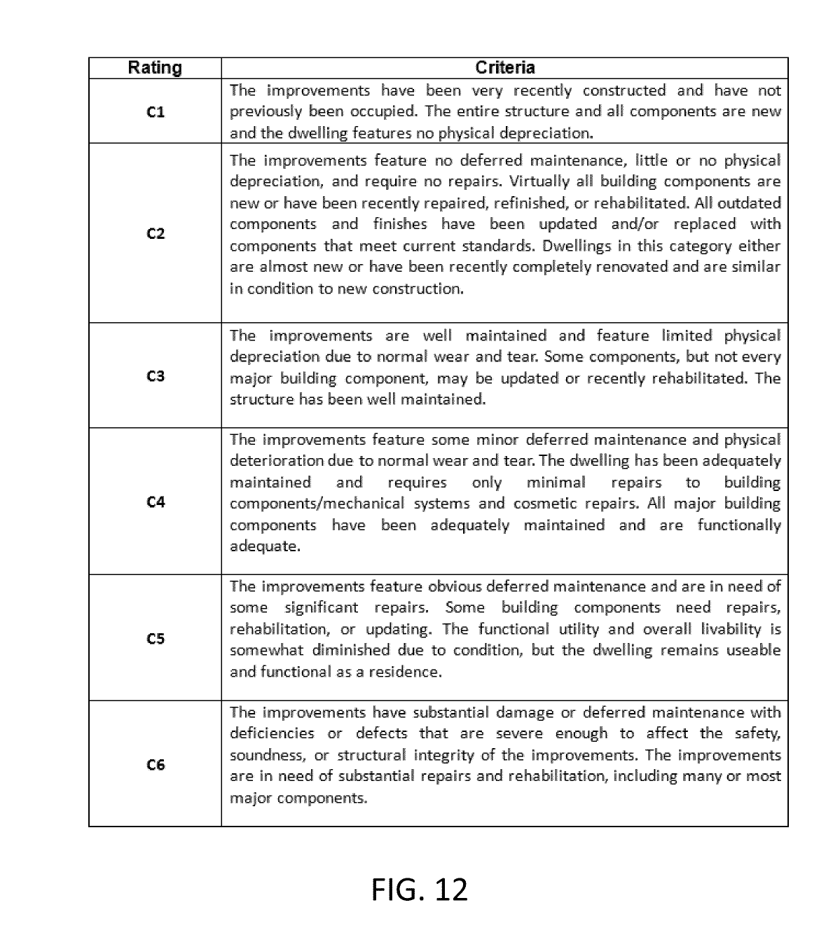

In other embodiments, appraisal and/or insurance information related to one or more of a plurality of structures can be obtained. The appraisals may be carried out by trained real estate appraisers that rate the condition of the property (C1-C6) through the Uniform Appraisal Dataset building condition codes shown in FIG. 12, or a similar rating system. The appraisal or insurance information may include one or more of age of the home, premium information, claim information, category of loss (e.g. wind and hail, fire, water, other) and other information. The appraisal and/or insurance records may comprise thousands, tens of thousands, hundreds of thousands, millions, tens of millions, or hundreds of millions of records on individual structures, and may comprise a national or regional set of records.

Construction information can be obtained from these sources through streamlined processes. The information may be obtained in a variety of electronic file formats, including delimited text files [CSVs], non-delimited text files, PDFs, word processing documents [Word], database backup files [Oracle, SQL Server], spreadsheet files [Excel]). The electronic file may be any electronic file suitable for storing data. In methods of this disclosure, converting the data to a standardized format can include converting the data to one or more different standardized formats. For example, in embodiments, the database may contain data converted into PDF format, and/or Word format, and/or Excel, and so on. In embodiments, all of the data may be in the same format, however, in typical embodiments the data will be in the form of several various formats.

### Conversion to Standardized Database

In embodiments of the computer-implemented method of the present disclosure, construction information in a variety of file formats (e.g., CSVs, PDFs, database backups) with different data layouts (e.g., tables and columns) can be used as input, and converted to a single, standardized relational-database-layout output as output. After the step of obtaining construction information, optional physical inspection information, and insurance and appraisal information is obtained, the following steps can be performed: preparation, loading, normalizing, mapping, and importing, as described below:
Preparation: take the file and make modifications to it so that it can be loaded into a database
Loading: load the output of prep into a database
Normalizing: modify the content and structure of the data in the database so that it fits preconditions to map. This includes organizing the fields and tables to minimize redundancy and dependency.
Mapping: map the content in the database (which is now in an arbitrary database layout) to a standardized database layout. The mapping may be performed in a variety of ways such as through the use of procedural code, creation of XSLT transforms or by using graphical mapping tools.
Importing: apply the mapping through an automated process to get the content into a standardized database layout.

The above processes can be performed by fixing corrupted and misaligned data, with streamlined user interfaces with minimal user input. As a result, the present method of conversion can process thousands of imperfect data files of permit data in a fraction of the time and cost that traditional Extract, Transform, and Load (ETL) software can perform. The present method of conversion can be performed by a person with average computer skills with a web browser.

### Audit

In an exemplary embodiment, the computer-implemented method of this disclosure optionally includes an audit to verify that the data out of import is substantially the same as what the source of the information provides, based upon automated internal checks and a manual review of the single-address open-records requests. For example, after an import is run, addresses within the original data submission may be randomly selected and single-address open-records requests for those to audit may be made.

### Coverage Area

In an exemplary embodiment, the computer-implemented method of this disclosure includes calculation of a geographical footprint of the “Coverage Area” for each building department based upon the geospatial coordinates of the properties that were within supplied building permits, the streets within the supplied building permits, and/or the census tract and block groups within the supplied building permits.

### Text Mining

The computer-implemented method of this disclosure, in embodiments, further includes identification of the type of permit within building permit data through the use of sophisticated text-mining analyses. The text mining may be used to classify the permits into one or more of the following types: Building, Electrical, Mechanical, Plumbing, HVAC, Pool, Roof, Foundation, Flooring, Drywall, Frame, Kitchen, Living Room, Family Room, Bathroom, Bedroom, Office, Hallway, Basement, Garage, Repair And Replace, Addition, and Remodel And Other. Further, classification of building permits into other categories that may occur to a skilled artisan not specifically recited herein may fall within the scope of this disclosure.

Text mining analyses may be prepared through Optical Character Recognition methods that convert typed texted into computer-readable text. The text mining analysis may use any of information retrieval, lexical analysis to study word frequency distributions, pattern recognition, tagging/annotation, information extraction, natural language processing, and data mining to perform the analysis.

In embodiments, SOLR (a Lucene-based software package; http://lucene.apache.org/solr/) may be used for text-mining analysis. The method of text-mining analysis may include developing a comprehensive set of key words that are present in building permit text that would be indicators of the category of work based on the input from subject matter experts in building permit data and experts in the construction industry. For example, if a key word “shingle” is returned, that may be used to categorized the permit as a Roof permit, if a key word “wiring” is returned, that may be used to categorize a permit as an Electrical permit, if a key word “drain” is returned, that may be used to categorize a permit as a Plumbing permit, etc. From the identified key words, a text-mining query can be created, and permits that match the query can be randomly selected. The identified permits may then be audited to identify keywords that will limit false positives. The query can then be revised and the steps repeated until an acceptable false positive rate is reached.

### Queries

Construction information related to a specific property or structure may be identified by querying the database for a specific property. Typically, the address of a specific property can be entered into an input form, and the query can return information about a structure or property from the database matching that address. Further, more sophisticated queries may be run that search for subsets of the properties based on age of the structure, presence of a permit, warranty information, building material deliveries, type of a permit/permit category, permit age, cost of job, number of permits in a specified time frame, appraised condition, loss ratio, type of loss, coverage area, and/or other factors. The queries may further provide for retrieval of data as well as manipulation of data such as calculations. The queries may result in an output such as those described below. The queries may be run using any suitable query language, such as SQL.

### Output

Output of the computer-implemented methods of this disclosure can include various parameters associated with construction information such as building permit data that would be potentially useful to insurance companies, including information on the date of the permit, the type of permit, and/or cost of the work. The output can include “yes”, “no”, or “unknown” as to whether there was a permit over a specified time period, as well as cost ranges and date ranges. The output can also include area averages of this information specific to a coverage area. The output may be specific for a particular property and include the number of permits over a specified time interval in each of the categories used for text mining analysis, such as “Building”, “Electrical”, “Mechanical”, “Plumbing”, “HVAC”, “Pool”, “Roof”, “Foundation”, “Flooring”, “Drywall”, “Frame”, “Window”, “Kitchen”, “Living Room”, “Family Room”, “Bathroom”, “Bedroom”, “Office”, “Hallway”, “Basement”, “Garage”, “Repair And Replace”, “Addition”, Remodel” and “Other” as well as permit age. The output may also include permit records which may include permit information such as permit number, permit type, description, work class, permit class, permit status, job cost, applied date, issue date, status date, contractors, and/or a list of inspections. The output may also include analyses such as an underinsurance assessment or property condition determination of a property. The output may be in a variety of formats including text, Microsoft Excel, HTML, PDF, and XML. Various embodiments of outputs are described below and are shown in the accompanying figures. However, the skilled artisan will recognize variations of the embodiments described below and shown in the figures that fall within the scope of this disclosure.

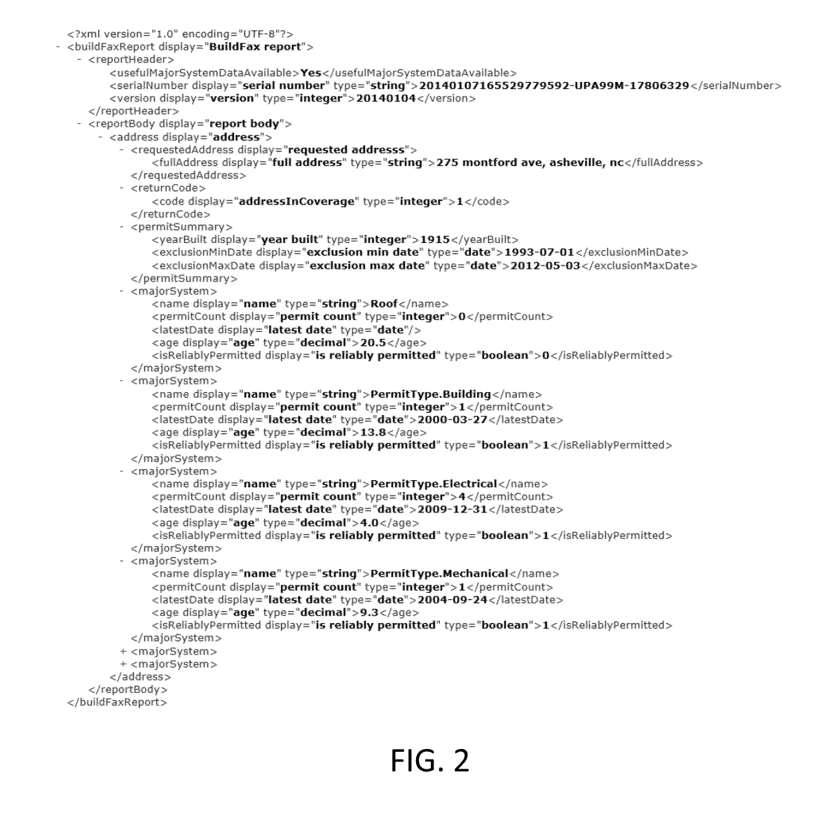

FIG. 2 is an example of an XML output according to an embodiment of this disclosure. The data includes permit age and type of permits for a target property and may be used to make property condition determinations.

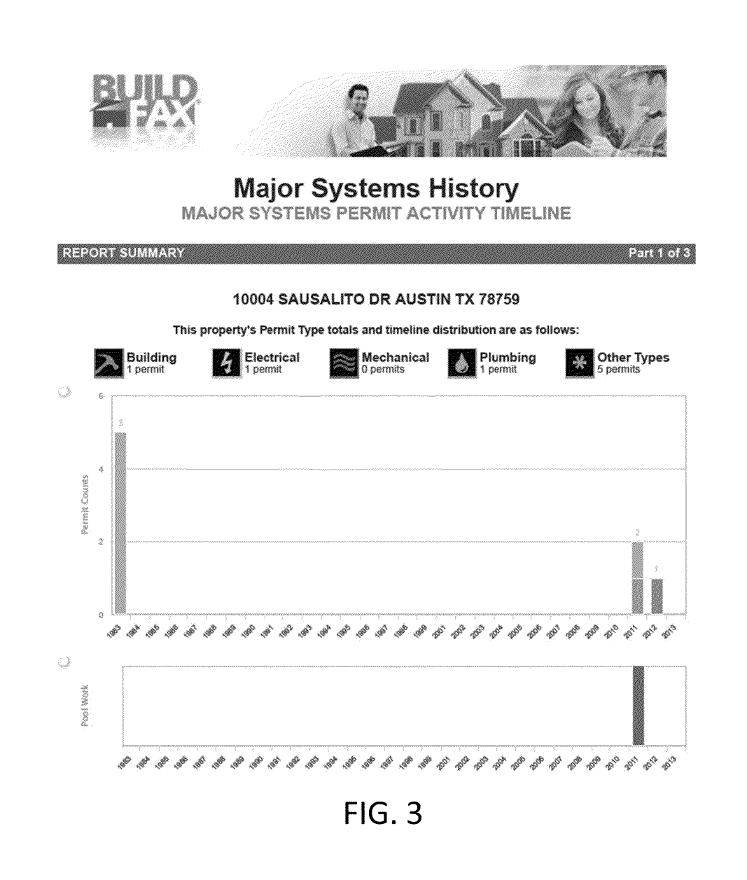

FIG. 3 is an example of an HTML output according to an embodiment of this disclosure. The data includes the number of permits in each category of permit including “Building”, “Mechanical”, “Electrical”, “Plumbing”, and “Other” as well as pool work as well as a timeline plotting the year of each permit. The categories are merely examples, and other categories including those described or not described herein may be included.

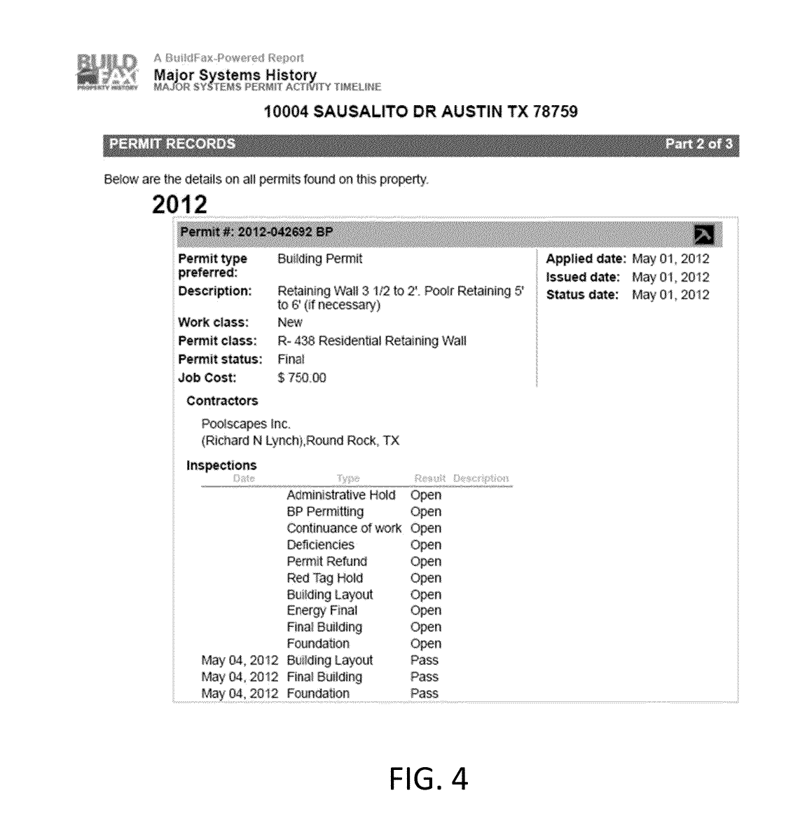

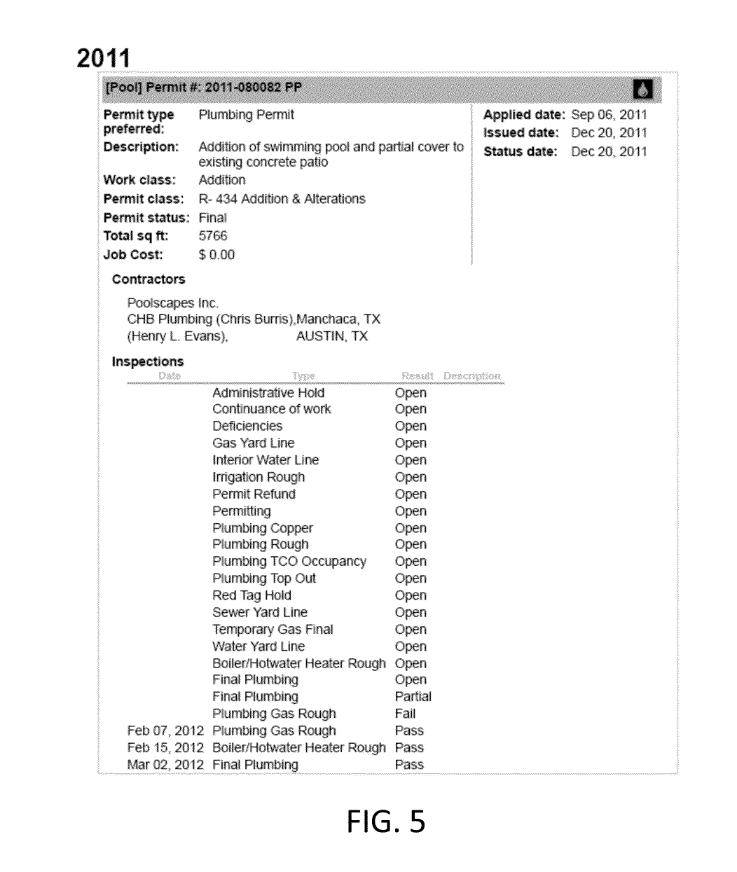

FIG. 4 is an example of an HTML output of a permit record for a Building permit, while FIG. 5 is an example of an HTML output of a permit record for a Plumbing permit. As illustrated, the permit records can include the property address for which the permit was issued, the type of permit, the year the permit was issued, the cost of the job being permitted, a description of the work involved in the job, the permit classification or category, contractors for the work and so on. Any of all of this information can be data mined in the data mining aspects of this disclosure.

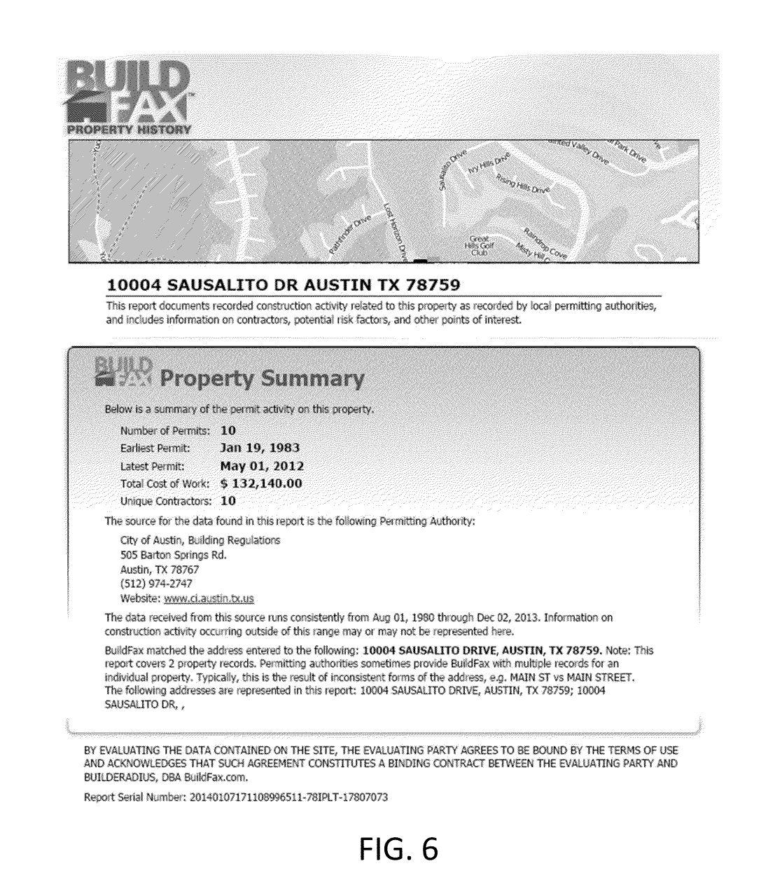

FIG. 6 is an example of an HTML output of a permit record summary according to embodiments of this disclosure. As illustrated, the permit summary output can include any one or more of a property address, the number of permits issued for that property, the date range during which the permits were issued, the total cost of the work permitted, the number of contractors involved, and the source of the data, such as a particular building department responsible for regulating the permits for that property.

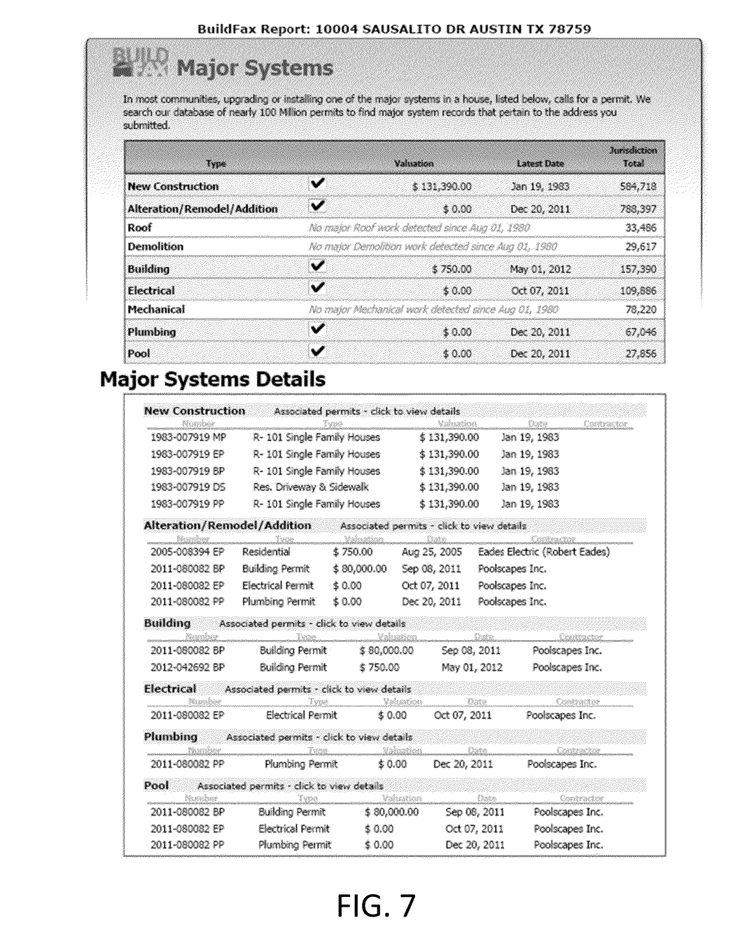

FIG. 7 is an example of an HTML output of a permit record summary of Major Systems. In most communities, upgrading or installing one of the major systems in a house calls for a permit. Major systems, for example, can include new construction, alterations, remodels, additions, roof replacement, demolition, building, electrical, mechanical, plumbing, and/or a pool. The data provided in the output can include any one or more of an itemization of whether or not and what type of major system permit was issued for any or all of the major systems for a particular target property, the cost of the improvement to the property, the date of the permit, and a total number of those types of permits granted in the regulation jurisdiction where the target property is located. The report or output can alternatively or additionally comprise similar information relating to other properties in the same jurisdiction for comparison. Such reports, as well as any output according to this disclosure, may be useful not only in the field of insurance but also in the field of real estate sales, especially for potential purchasers and/or homeowners and/or realtors who want to have a higher confidence level that the sales or listing price for a particular property is comparable to other properties in that jurisdiction with similar improvements.

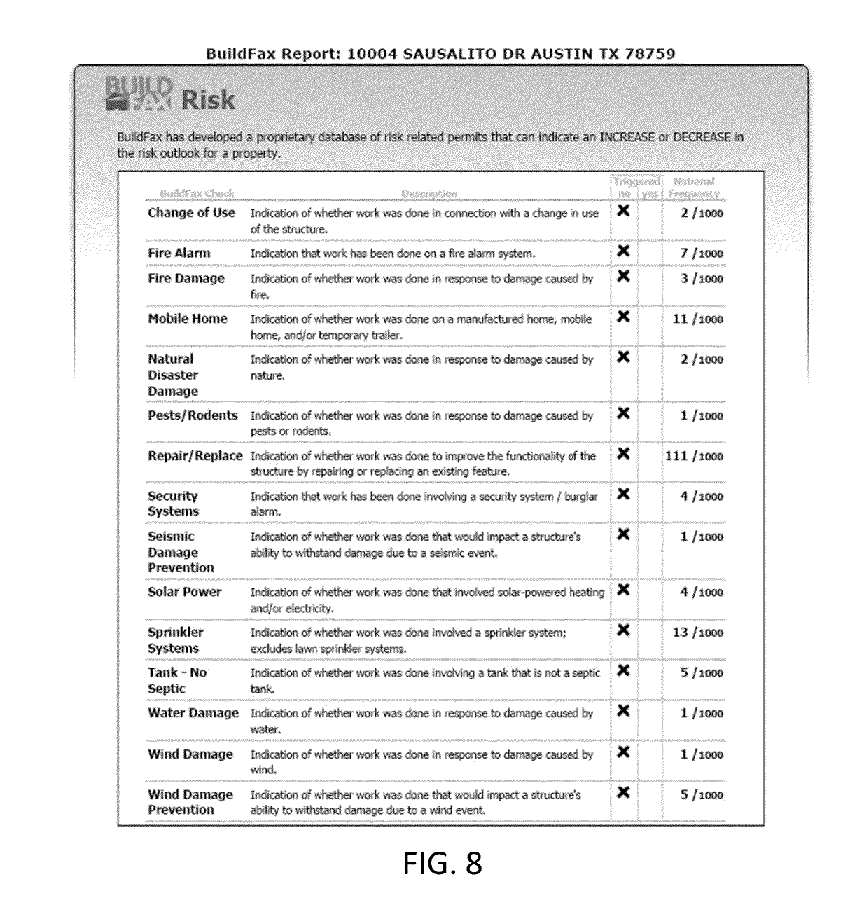

FIG. 8 is an example of an HTML output of types of permits that can indicate an increase or decrease in the underinsurance associated with a property or a high condition factor associated with a property. As illustrated, the target property did not have any “trigger” events that would affect the assessment for that property and the national frequency for the type of event can also be provided for comparison.

### Property Condition Estimation

Parameters from permit information such as the type of permit and age of the permit are mined from the permit information and may be used as proxies for property condition.

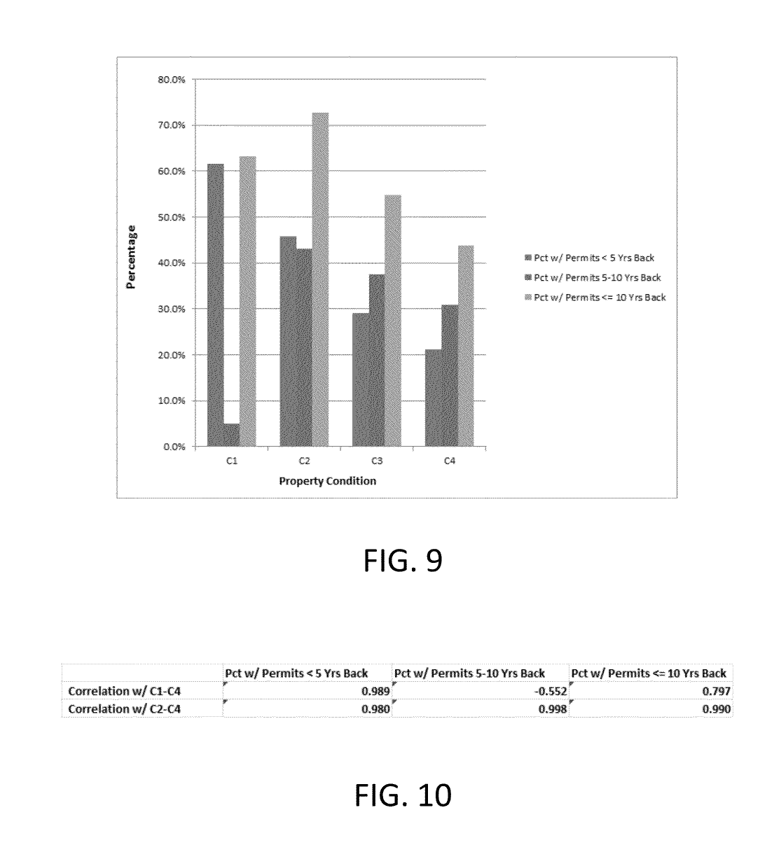

For example, FIG. 9 is a graph that shows the relationship between permit presence and appraiser condition ratings. As shown in the graph, properties having a permit less than five years old were more likely to be rated in better condition, and a general relationship between permit presence and appraiser condition ratings was observed for condition ratings C2-C4 when all three categories of permit age (i.e. permits less than 5 years old, 5-10 years old, and greater than 10 years old) are considered. FIG. 10 is a table showing the statistical correlation (R²) between permits of each age category with condition ratings C1-C4 and C2-C4. To produce the correlation, condition ratings were converted into scores where C1=4, C2=3, C3=2, and C4=1. As shown in the table, a positive correlation was shown for all data except the correlation of permits 5-10 years old with C1-C4.

In another embodiment, permit information may be converted into a property condition score. Such scores can for example be used by an insurance company in underwriting or in making other insurance determinations, or can be used by a lending company for mortgage determinations, or can be used by homeowners, buyers, and their real estate agents in evaluating property condition. Permit information that may be used in calculating the score may be the type of permit, age of permit, and total cost of work. For example, included in the scope of this disclosure is a computer-implemented method for estimating condition of a target structure, the method comprising: (a) identifying a target structure for which an estimated condition is desired; (b) identifying construction information associated with the target structure from a database comprising construction information for each of a plurality of structures, including the target structure; (c) estimating condition of the target structure based on the construction information associated with the target structure; and (d) optionally providing a property condition score for the target property. In one embodiment, the construction information is building permit data including one or more of number of building permits over a specified time period, building permit age, building permit category, and job cost. In embodiments, the condition of the target structure can be estimated based on a computer-implemented algorithm, statistical method, formula, or computational routine.

In preferred embodiments, the property condition score determination method may weigh various factors such as one or more of age of the property, number of permits over a specified time interval, permit categories, permit date or age, and/or cost of work. In an embodiment, the property condition score may be scaled 1-100, with higher scores indicating better condition. Thus, a newer property with a number of recent permits of high value in multiple categories would be rated higher than an older property with no permits. Further, the method of quantifying property condition score based on different variables can be adjusted according to various factors such as geographic area or coverage area, whether the property is commercial or residential, the value of the property, whether the property condition score is to be used for lending or underwriting, and other factors.

A specific example of such a method according to this disclosure could include a computer-implemented method for estimating condition of a target property, the method comprising:
(a) in response to one or more query of a database, optionally including target property age and replacement cost as part of the query submission, providing building permit data associated with a target property, wherein the database comprises building permit data for each of a plurality of properties, including the target property;
(b) using a computer processor, analyzing the building permit data to estimate condition of the target property based on one or more of a number of building permits for the target property, building permit dates, building permit category, job cost, or other information from the building permit data; and
(c) optionally providing a property condition score for the target property in the form of an electronic report.

For example, one way of performing the analysis can be to calculate the score based upon one or more of the criteria identified above, where newer permits are weighted more strongly than older permits (0-5 years weighted the most, 6-10 a bit less, 11-15 less than that, and 16+ essentially weighted as meaningless).

In embodiments, such methods can comprise analyzing the building permit data and providing a property score of:
(i) excellent when the number of building permits for the target property in the preceding 2 years is equal to 5 or more;
(ii) above average when the number of building permits for the target property in the preceding 5 years is at least 1 and the job cost is at least half assessed value of the target property at the time of the permit;
(iii) average when the number of building permits for the target property in the preceding 10 years is from 2-4 and the job costs aggregated range from $5-20,000;
(iv) below average when the number of building permits for the target property in the preceding 15 years is less than an average number of building permits for other properties in the same jurisdiction over the same time period; or
(v) poor when the number of building permits for the target property in the preceding 20 years is equal to 0.

Method and system embodiments may analyze various factors such as one or more of age of the property, number of permits over a specified time interval, permit categories, permit date or age, and/or cost of work (job cost). The property condition can be based on a numerical score, for example, excellent being 81-100, above average being 65-80, average being 50-64, below average being 30-49, and poor being below 30. For purposes of this example, these ranges are arbitrarily applied and any other ranges could be used depending on the particular situation. When using age of the property in the analysis, any age range can be used including from 0-5 years, 5-10 years, 10-20 years, 20-30 years and above 30 for example, or any range in between. The number of permits over a specified time interval can be 0, 1, 2, 3, 4, 5, 6, 7, 8, 9, 10, 11, 12, 13, 14, 15, 16, 17, 18, 19, or 20 for example or any range in between, such as from 0-2, or from 1-3, or from 4-5, and so on. The specified time interval, for example, may be over the past 1, 2, 3, 4, 5, 6, 7, 8, 9, 10, 12, 15, 20, 25, or 30 years or more, or any range in between. However, a skilled artisan will recognize that more recent permits (e.g. within the past 5 or 10 years) will be more meaningful in determining property condition than older permits (e.g. 20 years or older). Categories for permit age can range from 0-5 years old, or from 6-10 years old, or from 11-15 years old, or from 16-20 years old, or from 21-30 years old, or over 30 years old. The job cost for the permitted project can be based on comparison of the actual job cost with the average job cost other properties of the same age exhibit and/or on a comparison with the appraisal value or tax assessment value (i.e., assessed value) of the property before the update. The job cost factor can alternatively or in addition be used as an absolute value, such as properties graded in excellent condition have improvements worth 10% of the replacement cost of the property or more over the past 10 years. The type of project can range from electrical, to plumbing, mechanical, building, pool, etc. or any combination thereof. For example, a property may score a condition of excellent if within a specified time period such as the last 5 years the target property had permits in 3 of the above-mentioned categories, such as an electrical permit, a pool, and a plumbing permit. Or a property/structure may score a condition of average if compared to other similar properties/structures in the same jurisdiction the target property had the same number of permits over the specified time interval. These factors can be used in any combination to perform the analysis. Preferred are methods and systems where one or more of these factors is used in a computer program operably configured for processing and analyzing the data and making a determination about property condition. Any one or more of the factors used in the analysis can be weighted most or least in a particular analysis. Additionally or alternatively, all factors used in the analysis can be assigned the same weight.

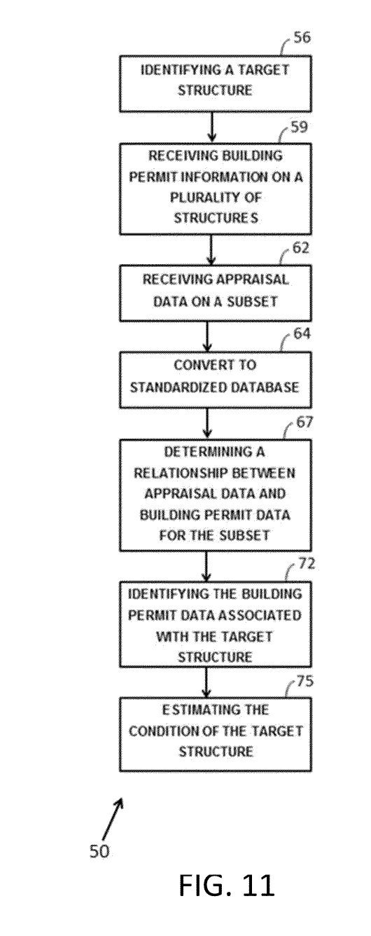

FIG. 11 shows an embodiment 50 of a computer-implemented method for estimating the condition of a target structure, the method comprising identifying a target structure for which an estimated condition is desired 56; receiving construction information including but not limited to building permit data related to a plurality of structures in computer-readable form 59; receiving appraisal data on the condition of a subset of the plurality of structures 62; converting the building permit data and appraisal data into a standardized database format 64; determining a relationship between the appraisal data and building permit data for the subset of structures 67; identifying the building permit data associated with the target structure 72; and estimating the condition of the target structure based on the building permit data associated with the target structure and the relationship between the appraisal data and building permit data for the subset of structures 75.

The step of identifying a target structure may be carried out by an insurance agent, lending agent, or consumer, and may include identifying a structure for which underwriting or other interest is desired. The steps of receiving construction information such as building permit data and appraisal data and converting the data to a standardized database format may be carried out as previously described. The appraisal data may comprise hundreds of thousands of records, including 100,000; 200,000; 300,000; 400,000; 500,000; 600,000; 700,000; 800,000; 900,000; 1,000,000, or more. The appraisals may be carried out by trained real estate appraisers that rate the condition of the property through the Uniform Appraisal Dataset building condition codes shown in the table in FIG. 12, or a similar rating system. The step of determining a relationship between the appraisal data and building permit data for the subset of structures may include any statistical algorithm or formula—for example, a cluster analysis around the building condition codes—to determine the relationship between permit presence and building condition. The statistical algorithm or formula may be one of several classification methods known in the art, including cluster analysis such as hierarchical clustering and k-mean clustering, linear classifiers such as Fisher's linear discriminant and logistic regression, support vector machines, k-nearest neighbor, decision trees, neural networks, Bayesian networks, and Hidden Markov models.

The step of identifying the construction information including but not limited to building permit data associated with the target structure may include querying the standardized database for an address of the target structure so that construction information such as building permit data associated with the address is returned. Further, any suitable algorithm, statistical method, formula, or computational routine may be used to estimate the condition of the target structure based on the identified building permit data associated with the target structure and the relationship between the appraisal data and building permit data for the subset of structures.

### Loss Analysis and Insurance Estimation

Additional factors such as the age of the home, total losses paid by an insurance company in the form of claims, collected premiums, and category of loss are provided by insurance carriers and added to permit data in the standardized database so that a loss analysis can be run. Representative loss categories include those from fire, water, wind or hail, or other. The loss analysis may be performed on a subset of collected building permit data. In embodiments, loss records comprising millions of records, which may be 1, 10, 20, 30, 40, 50, 60, 70, 80, 90, or 100 million loss records or more, may be provided.

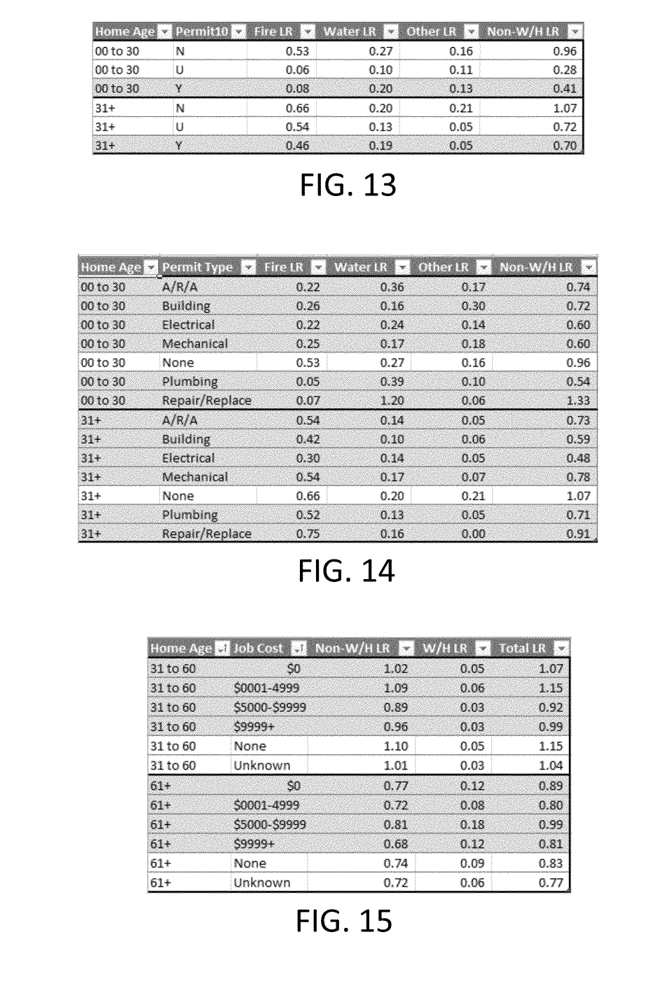

FIG. 13 shows a table with a loss analysis according to property age and whether the property had a permit (yes, no, unknown) in the past 10 years and according to fire, water, and other. As shown in the table, the presence of a permit was associated with reduced loss ratios, particularly for fire in newer homes. FIG. 14 shows a similar loss analysis according to permit category. As shown in the table, loss ratios were generally reduced for properties having all permit types except for repair and replace in comparison to properties with no permits, especially for non-wind and hail damage (which is fire, water, and other combined). FIG. 15 shows a similar loss analysis according to job cost.

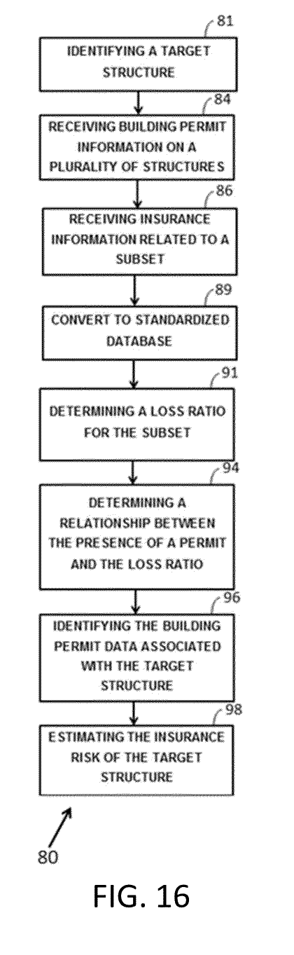

FIG. 16 shows another embodiment 80 of a computer-implemented method for determining underinsurance of a target structure, the method comprising identifying a target structure for which underinsurance or condition is desired 81, receiving construction information including but not limited to building permit data related to a plurality of structures in computer-readable form 84, receiving insurance data related to a subset of the plurality of structures comprising total losses paid by an insurance company in the form of claims and collected premiums 86, converting the building permit data and insurance data into a standardized database format 89, determining a loss ratio for the subset of the plurality of structures based on the whether a permit is present 91, determining a relationship between the presence of a permit and the loss ratio 94, identifying the building permit data associated with the target structure 96, and estimating underinsurance of the target structure based on the identified building permit data associated with the target structure and the relationship between the presence of a permit and the loss ratio of the subset of structures 98.

Specific computer-implemented methods for determining underinsurance for a target structure, can comprise one or more or all the following steps:

(1) in response to one or more query of a database, providing a yes, no, or unknown response concerning whether a building permit exists for a target structure over a particular time period, such as in the past 10 years, or within the last year, or 20 years or more, for example;

(2) wherein the database comprises building permit data and insurance data for a plurality of structures, including the target structure;

(3) using a computer processor, determining a loss ratio, which loss ratio comprises a total amount of insurance claims divided by a total amount of insurance premiums, for one or more subset of the plurality of structures, wherein each subset is organized by: (a) structure age range, and (b) permit status for structures in the subset, where the permit status is: (i) yes, if a permit is present, (ii) no, if no permit is present, and (iii) unknown, if unknown whether a permit is present; and

(4) providing an underinsurance estimate for the target structure by assigning the target structure the same loss ratio for the subset of structures with a structure age range and permit status the same as the target structure.

Examples of the particular time period may be 1 year, 2 years, 5 years, 10 years, 15 years, 20 years, or any time period in falling in between. Such methods can alternatively or additionally include organizing the subsets by type of loss claimed for the subset of structures and/or by the type of building permit for the subset of structures. The type of loss claimed can be one or more of fire, water, wind, hail, wind and hail, other and/or the type of building permit can be one or more of a building, electrical, mechanical, plumbing, HVAC, pool, roof, foundation, flooring, drywall, frame, kitchen, living room, family room, bathroom, bedroom, office, hallway, basement, garage, repair and replace, addition, and remodel and other permit.

In embodiments, the subsets or structures can be further organized by coverage areas of one or more building departments serving one or more of the plurality of structures, and wherein underinsurance or condition of the target structure is estimated based on a coverage area in which the target structure is present.

Such methods, or any method of this disclosure, can include a step of generating an electronic report relating to the analysis performed, such as generating an electronic report relating to the underinsurance or condition of the target structure.

In embodiments, the step of identifying a target structure may be carried out by an insurance agent, lending agent, or consumer, and may include identifying a structure for which underwriting is desired. The steps of receiving construction information such as building permit data and converting the data to a standardized database format may be carried out as previously described. The step of receiving insurance information related to a subset of the plurality of structures may also include conversion of this information to a standardized database format. The step of determining a loss ratio for the subset of the plurality of structures based on whether a permit is present may include segmenting the plurality of structures to those for which no permit is present, a permit is present, and permit status is unknown over a specified time period and calculating the loss ratio as the total expenditures of claims divided by the total income of premiums for each segment as shown in FIG. 13. Alternatively, the plurality of structures may be divided according to the type of permit as shown in FIG. 14 or job cost as shown in FIG. 15 and the loss ratios may be calculated according to each category of permit. The step of determining a relationship between the presence of a permit and the loss ratio may include an analysis of loss ratios in each permit category (present, absent, or unknown, or specific types of permits) to determine whether the presence of a permit results in a significant reduction of the loss ratio compared to if no permit is present. This analysis may include any statistical algorithm or formula to determine whether the differences in loss ratios are significant such as the classification approaches described above. The step of identifying the building permit data associated with the target structure may include querying the standardized database for an address of the target structure so that building permit data associated with the address is returned. Further, any suitable algorithm, statistical method, formula, or computational routine may be used to estimate underinsurance or condition of the target structure based on the relationship between the presence of a permit and the loss ratios of the subset of structures and the building permit data associated with the target structure. For example, if an analysis shows that, on average, homes over 15 years old with permits in the past 10 years have loss ratios that are 0.05 lower than homes with no permits in the past 10 years, then homes with no permits in the past 10 years should likely pay 5% more in insurance than similarly-situated homes with permits in the past 10 years.

Combined Analysis with Appraiser Condition Information and Loss Information

In one embodiment of the method of the present disclosure, appraiser condition records and loss records may be used together with structure construction information in a combined analysis to establish criteria, guidelines, or benchmarks of property condition and/or underinsurance within the construction information. These criteria, guidelines, or benchmarks are one or more characteristics of the construction information that indicate better condition or reduced extent of underinsurance as evidenced by the appraisal records and/or loss records. For example, as a result of analysis of such data, it may be determined that the presence of a certain type of permit is indicative of better condition as indicated by appraisal ratings according to Uniform Appraisal Dataset building condition codes, and allows an estimation of “good” condition for structures that have that particular permit. Similarly, the analysis may determine that the presence of a permit meeting a certain job cost threshold within a certain number of years is indicative of better condition as indicated by claims for losses being reduced or absent for structures meeting this criteria and allow for an estimate of “better” condition for structures with construction information having those characteristics. For example, any permit with a job cost of at least $5000 occurring within the past five years may serve as criteria of better condition. The analysis may also determine that a combination of construction information characteristics is indicative of better condition. For example, an example of a combination of factors as criteria of better condition is the presence of a roof permit with a job cost of at least $10,000 occurring within the past five years. Another example of a combination of factors as criteria of better condition is the presence of a kitchen remodel permit and a bathroom remodel model permit with a total job cost of at least $20,000 occurring within the past ten years. Thus, the criterion or criteria for property condition or underinsurance may be one or more characteristics within the construction information that are indicative of better condition and/or reduced extent of underinsurance, where better condition and/or reduced probability of underinsurance is indicated by better appraiser condition ratings and/or reduced claims for losses. In this way, criteria, guidelines, or benchmarks within the construction information are based on the appraiser condition information, loss information or both. The criteria may also be as simple as an indication of whether a permit is present, absent, or unknown (Y/N/unknown), wherein the presence of a permit indicates a better condition or reduced losses, or based on a complex set of factors such as those discussed herein. Based on this criterion or these criteria, the condition of a structure may be estimated. The condition estimation may simply be a binary determination (e.g. better or worse, good or bad), a qualitative score (such as excellent, above average, average, below average, and poor), or a quantitative score (e.g. 1-10, 0-100) according to methods discussed within this disclosure. Further, the condition estimation may be according to one of the classification methods discussed within this disclosure, wherein the condition is classified according to specific categories of condition such as the Uniform Appraisal Dataset building condition codes or similar rating system. The classification method may include but is not limited to hierarchical clustering, k-means clustering, Fisher's linear discriminant, logistic regression, support vector machines, k-nearest neighbor, decision trees, neural networks, Bayesian networks, and Hidden Markov models.

The analysis may use the data together simultaneously, or in different stages. For example, the analysis may use the construction information together with the appraiser condition information in a first stage to produce criteria of property condition, and then the property condition criteria may be fine-tuned based on loss records or other data from insurance carriers. The analysis may be performed by a processor using data mining techniques known in the art such as the classification methods described herein or other methods. After criteria for property condition may be obtained, the property condition of a target structure may be estimated by identifying the construction information associated with a specific target structure and comparing that information with the established criteria, guidelines, or benchmarks using a processor. Similarly, the method of the present disclosure may be modified to estimate the liability or extent of underinsurance of a structure instead of estimating property condition.

The analysis may also be performed on structures having a specialized set of characteristics to produce specialized criteria for property condition and/or underinsurance. The specialized characteristics may relate to the age of the structure, the age of the development containing the structure, the builder of the structure, whether the home has been foreclosed, the school district of the structure, the town, zip code, or coverage area of the structure, the median or average household income of the town, zip code, or coverage area of the structure, the median or average net household worth of the town, zip code, or coverage area of the structure, the median or average home value of the town, zip code, or coverage area of the structure, the number of foreclosures in the town, zip code, or coverage area of the structure, whether the structure is in a gated community, whether the structure is adjacent to a golf course or on a waterfront, whether the structure has a view of a body of water or mountains, whether the structure has a pool, whether the structure has a screened porch or patio, the size of the property, the number of bedrooms, the size of the structure in square footage, the presence and size of a garage, the assessed value of the structure, the appraised value of the structure, the last sale price of the structure, and other factors that may indicate homes of higher value or similar determination. The specialized criteria may be used to estimate the condition or underinsurance of structures of homes of higher value as indicated by the specialized set of characteristics. Further, similar characteristics may be used to produce specialized characteristics for homes of low value or average value.

One embodiment of this disclosure comprises a computer-implemented method of estimating the property condition for a structure comprising:
providing, in a database, computer-readable data comprising:
a national data set of construction information for a plurality of structures
a data set of loss records for a subset of the plurality of structures; and
a data set of appraisal records for a subset of the plurality of structures;
querying the computer readable data to identify the construction information for a target structure; and
processing the computer-readable data with a processor to:
determine one or more criteria of property condition based on the national data set of construction information, the data set of loss records, and the data set of appraisal records, wherein the criteria of property condition are one or more characteristics within the construction information; and
compare the identified construction information for the target structure with the one or more criteria of property condition to estimate a property condition of the target structure.

Another embodiment of this disclosure comprises a computer-implemented method of estimating underinsurance for a structure comprising:
providing, in a database, computer-readable data comprising:
a national data set of construction information for a plurality of structures;
a data set of loss records for a subset of the plurality of structures; and
data set of appraisal records for a subset of the plurality of structures;
querying the computer readable data to identify the construction information for a target structure; and
processing the computer-readable data with a processor to:
determine one or more criteria of underinsurance based on the national data set of construction information, the data set of loss records, and the data set of appraisal records, wherein the criteria of underinsurance are one or more characteristics within the construction information; and
compare the identified construction information for the target structure with the one or more criteria of underinsurance to estimate probability of or an extent of underinsurance of the target structure.

Another embodiment of this disclosure comprises a computer-implemented method of estimating the property condition for a structure comprising:
providing, in a database, computer-readable data comprising:
a national data set of construction information for a plurality of structures, wherein the construction information comprises building permits, warranty records, and/or building material deliveries;
a data set of appraisal records for a subset of the plurality of structures wherein the buildings are rated C1-C6 according to the Uniform Appraisal Dataset building condition codes; and
a data set of loss records for a subset of the plurality of structures wherein the loss records comprise insurance claims for the subset of structures
querying the computer readable data to identify the construction information for a target structure; and
processing the computer-readable data with a processor to:
determine one or more criteria of property condition within the data set of construction information based on a relationship between the data set of construction information and the data set of appraisal records, and based on a relationship between the data set of construction information and the data set of loss records, wherein the criteria of property condition are one or more characteristics within the construction information; and
compare the identified construction information for the target structure with the one or more criteria of property condition to estimate a property condition of the target structure.

Another embodiment of this disclosure comprises a computer-implemented method of estimating the property condition for a structure comprising:
identifying a target structure;
querying computer-readable data in a database comprising:
a national data set of construction information for a plurality of structures;
a data set of loss records for a subset of the plurality of structures; and
a data set of appraisal records for a subset of the plurality of structures;
wherein querying the computer readable data comprises identifying the construction information for a target structure within the plurality of structures;
processing the computer-readable data with a processor to:
determine one or more criteria of property condition based on the national data set of construction information and the data set of loss records, wherein the criteria of property condition are one or more characteristics within the construction information;
refine the determined criteria of property condition based on the data set of appraisal records; and
compare the identified construction information for the target structure with the refined criteria of property condition to estimate a property condition of the target structure.

Another embodiment of this disclosure comprises a computer-implemented method of estimating the property condition for a structure comprising:
identifying a target structure;
querying computer-readable data in a database comprising:
a national data set of construction information for a plurality of structures;
a data set of loss records for a subset of the plurality of structures; and
a data set of appraisal records for a subset of the plurality of structures;
wherein querying the computer readable data comprises identifying the construction information for a target structure within the plurality of structures;
processing the computer-readable data with a processor to use the identified construction information for the target structure to classify the property condition of the target structure based on the national data set of construction information, the data set of loss records, and the data set of appraisal records;
wherein the target structure is classified based on a classification algorithm.

In any embodiment of this disclosure, the construction information may be building permit data.

In any embodiment of this disclosure, the criteria of property condition is based on one or more or a combination of the following:
whether a building permit within a particular time frame is present, absent, or unknown;
a number of building permits within a particular time frame;
building permit age;
type of building permit; and
job cost.

In any embodiment of this disclosure, the property condition of the target structure may be estimated as a numeric score or a categorical score;

In any embodiment of this disclosure, the national data set of construction information comprises more than 100,000 total records, such as for example, 100 million building permit records, more than 10 million insurance loss records, and more than 100 thousand appraisal records.

In any embodiment of this disclosure, any of the processing steps, such as analyzing, determining, querying, comparing, identifying, refining, assigning, providing, performing, and so on, is capable of being performed in 30 minutes or less, especially in the case where hundreds of thousands or millions of records are being processed.

In any embodiment of this disclosure, a subset of the national data set of construction information for a plurality of structures that correspond to a specific characteristic is obtained.

In any embodiment of this disclosure, the specific characteristic is high home value, and criteria of property condition are specialized for structures with high home value.

### Modeling

In an exemplary embodiment, the present computer-implemented method uses construction information on a plurality of structures, including but not limited to building permit information, warranty records, and building material or equipment deliveries to calculate an area average property condition or loss ratio for different geographical areas (e.g., zip5, city, county, zip3, Metropolitan Statistical Area (MSA), and state). The area average property condition can be either a score or average ages of particular permit types or average job costs. The area average may be returned in situations where the construction information is incomplete or unknown for a particular structure. For example, the area average property condition or average ages of particular permit types based on the coverage area may be returned if the property is within a coverage area, and if the property is not within a coverage area, area averages for the smallest area that both contains the submitted address and for which the area average is available may be returned.

In addition, input data from mortgage lenders, appraisers, or insurers can be used to identify correlations between input values and property condition to estimate property condition where the exact property condition of a structure in unknown. For example, this can be based on a correlation between owner demographics and property condition.

### Data Driven Underinsurance Detection

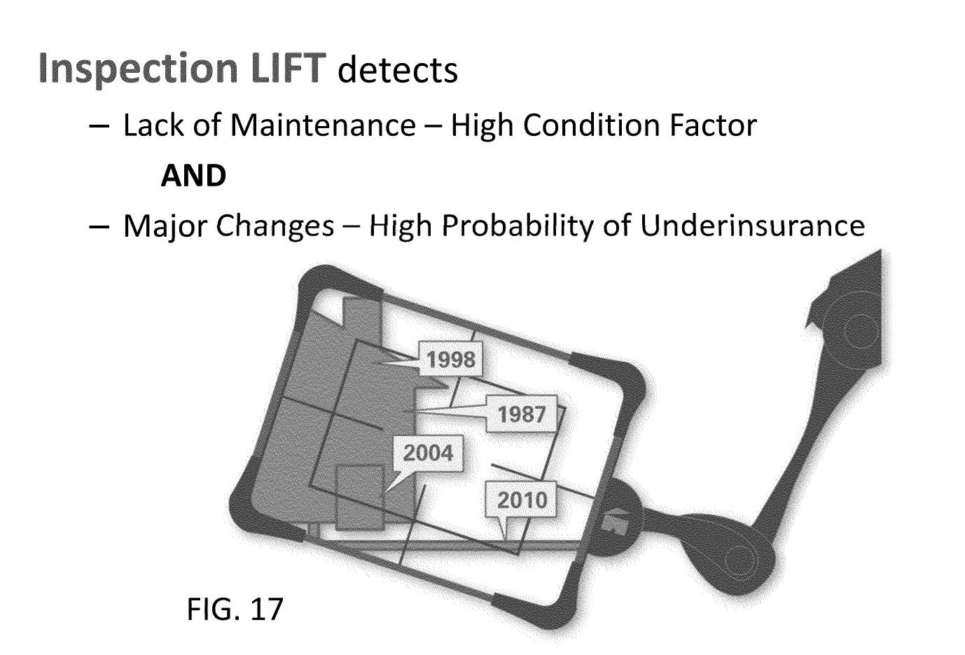

An embodiment of the present invention provides a new targeted underinsurance detection solution developed to help carriers evaluate underinsurance and condition for residential and commercial policies on their existing book of business. The present invention characterizes property conditions through building permits, enabling carriers to prioritize property inspections, such as physical property inspections, and understand which properties should have more general lower-cost physical inspections and which properties should have more detailed, expensive physical inspections, and which homes do not need any physical inspection. This is shown schematically in FIG. 17.

As shown in FIG. 17, high condition factors can be associated with a lack of maintenance on a property (Low Maintained Condition), while underinsurance can be associated with major changes made on a property since underwriting of the initial insurance policy (Highly Improved Condition). The presence of a high condition factor may result in an increased likelihood of loss claims on an insurance contract, such as, for example, an older roof or older windows being more likely to sustain costly damage during a severe thunderstorm with hail. Underinsurance results when the insured property has significantly increased in value due to the addition of significant upgrades, such as a pool or additional square footage, and the original insurance contract does not take into account the increased value. Thus, condition factors and underinsurance represent both ends of the spectrum.

The present invention capitalizes on building permit information to determine the condition or underinsurance of a property. For example, as shown in the diagram in FIG. 17, building permit information associated with a structure may include such factors as initial construction in 1987, a new roof in 1998, a new HVAC unit in 2004, and new plumbing in 2010. Such factors may be used to indicate whether the home is being maintained since the initial construction. The building permit information may be obtained from the construction information converted into a standardized database format described above. The construction information can include permit information such as the type of permit, number of permits, age of permit, and total cost of work, as well as the year that the target structure was built.

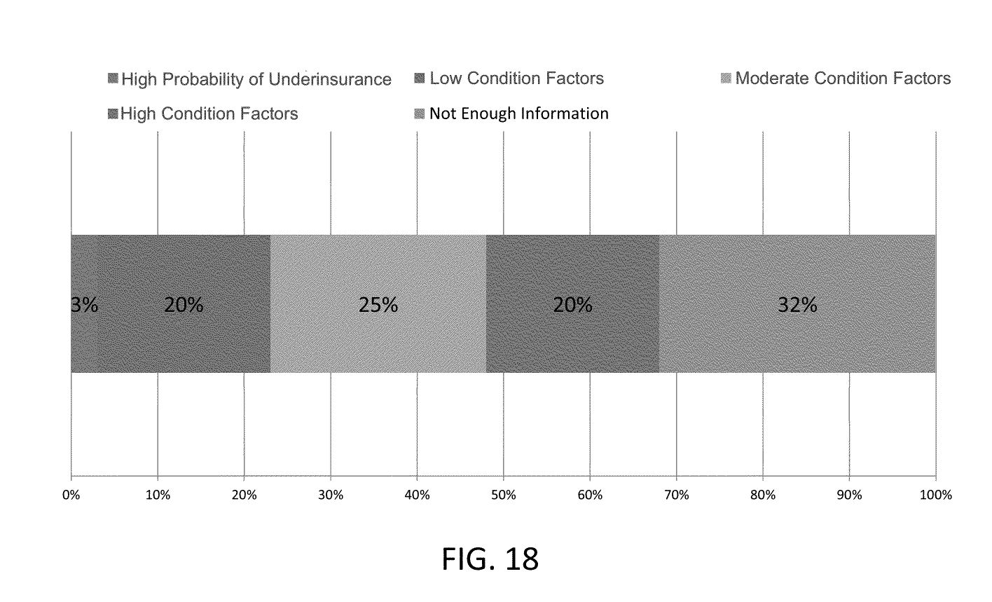

The categories that the present invention is capable of identifying include High Probability of Underinsurance (Highly Improved Condition), Low Condition Factors (Highly Maintained Condition), Moderate Condition Factors (Moderately Maintained Condition), High Condition Factors (Low Maintained Condition), or Not Enough Information on File to Make a Determination. FIG. 18 shows the distribution of categories according to the inventor's national database of properties. As can be seen in the figure, 3% of properties had a High Probability of Underinsurance, 20% of properties had Low Condition Factors, 25% of properties had Moderate Condition Factors, 20% of properties had High Condition Factors, and 32% of properties had Not Enough Information. Properties with any type of missing data such as the original permit or building information may fall into the Not Enough Information category.

The invention can help ensure that the scope of coverage offered by an insurance policy is commensurate in scope or closely aligned with the condition of the insured property through the building permit database described previously to identify:

1. Homes that need to be physically inspected because they are not being properly maintained (lack of any permits for a long while);

2. Homes that do not need to be physically inspected, because, even though they are older, the permit history indicates they are being maintained;

3. Homes that need to be physically inspected because they have had a significant remodel/addition since the policy was initially underwritten.

In one embodiment, a computer-implemented method for estimating condition of a target structure is provided. The method may comprise identifying a target structure for which an estimated condition is desired, identifying construction information associated with the target structure from one or more query of a database, which database comprises construction information for a plurality of structures, including the target structure, processing the construction information with a computer to estimate underinsurance or condition of the target structure based on the construction information associated with the target structure.

In another embodiment, a computer-implemented method for generating an inspection recommendation for a target structure is provided. The method may comprise identifying a target structure for which an inspection recommendation is desired, identifying construction information associated with the target structure from one or more query of a database, which database comprises construction information for a plurality of structures, including the target structure, and processing the construction information with a computer to generate an inspection recommendation for the target structure based on the construction information associated with the target structure.

In these embodiments, the construction information may be building permit data including one or more of number of building permits within a particular time frame, building permit age, building permit category, and job cost. The construction information may also be year built. A query of the database of construction information may include data mining of the building permit data for key words to determine one or more categories of building permit data, wherein the underinsurance or condition of the target structure is estimated based on the one or more categories of building permit data associated with the target structure. The building permit category may be one or more of building, electrical, mechanical, plumbing, HVAC, pool, roof, foundation, flooring, drywall, frame, window, siding, kitchen, living room, family room, bathroom, bedroom, office, hallway, basement, garage, repair and replace, addition, and remodel.

As a practical example of the above, an end-user may query a remote database by entering in the address or geographic location of a target structure. The end-user may query the remote database from a client computer accessing a remote server. The remote database may contain building permit information about the target structure. The query may include a series of keywords targeted to identify relevant building permits as described previously. The user query may also return the year built or age of the target structure by identifying this information from the original building permit for construction of the target structure. As a result of the query, a number of building permits may be returned that are associated with the target structure.

In one example, the user query may return no additional permits since the year the structure was built, in which case the methods of the invention may return a category of high condition risk with a recommendation for a detailed, extensive inspection. In another example, the user query may return a certain number of building permits over the last ten years, such as 2, 3, 4, 5, 6, 7, 8, 9, 10 or more, such as for example a new roof, new siding, and a remodeled kitchen, in which case the methods of the invention return a category of low condition risk and a recommendation not to inspect or to have only a general inspection of the property. In another example, the user query may return a significant addition to the property over the last 5 years such as a swimming pool or additional room, in which case the methods of the invention may return a category of high probability of underinsurance and a recommendation for a detailed inspection of the property to confirm the addition. In some embodiments, a significant addition or improvement can be defined as adding a specified amount to the value of the home, for example, adding 1%, 2%, 3-5%, 6-9%, 10%, 15-25%, 30-50%, 60-100% of the value of the home to the value of the home. The determination as to whether an inspection is recommended for a particular property and/or structure can be based on the amount of the value added to the property and/or structure, such as no inspection for value added of less than 1%, 2%, 5%, or 10%, or inspection recommended for a value added in excess of 1%, 2%, 5%, 10%, or 25%. The purpose for recommendation for inspection of the property can be to confirm the estimated physical condition of the target property determined by the data.

The methods of the invention may return the number and types of building permits over a certain time period associated with the target structure based on keyword searching, or may return a category and/or recommendation such as those described above, or may return both the number and types of building permits and a category and/or recommendation. In embodiments, the methods of the invention may rely on a specific algorithm or computer instructions for providing a recommendation, such as the following conditional Boolean expressions:

IF Building Permits over Last 5 years=2 or more AND Year Built=Less than 10 years ago, THEN Category=Low Condition Factor AND Recommendation=Do Not Inspect

IF Building Permits over Last 5 years=1 AND Year Built=More than 20 years ago THEN Category=Moderate Condition Factor AND Recommendation=General Inspection

IF Building Permits over Last 10 years=3 or more AND Year Built=Less than 10 years ago, THEN Category=Low Condition Factor AND Recommendation=Do Not Inspect

IF Building Permit Category=Pool AND Building Permit Age=Less than 5 years ago, THEN Category=High Underinsurance Factor AND Recommendation=Detailed Inspection

IF Building Permits over last 10 years=1 or less AND Year Built=More than 30 years ago THEN Category=High Condition Factor AND Recommendation=Detailed Inspection

IF Building Permits over Last 10 years=2 or more AND Average Building Permit Age=<5 years, THEN Category=Low Condition Factor AND Recommendation=Do Not Inspect

IF Building Permit over Last 5 years=2 or more, AND Average Job Cost=>$10,000, THEN Category=Low Condition Factor AND Recommendation=Do Not Inspect

IF Building Permit Category=Addition, Building Permit Age=<5 years, AND Job Cost=>$10,000 THEN Category=High Probability of Underinsurance AND Recommendation=Detailed Inspection

These conditional statements can be constructed from any combination of number of building permits over a specified time interval, building permit age, building permit category, and job cost. Further, the specific algorithm or computer instructions may use any type of Boolean operator including AND, OR, NOT, and XOR. Conditional Boolean statements may be programmed in any suitable computer-readable language, non-limiting examples of which include SQL, C, C++, C#, Visual Basic, Java, Python, Perl, PHP, Html, CSS, and JavaScript.

Alternatively, other types of algorithms may be used to estimate the condition or to determine probability of underinsurance of a structure based on construction information including building permit information associated with the structure. The algorithms may include machine learning or classification methods known in the art, including Amazon Machine Learning, cluster analysis such as hierarchical clustering and k-mean clustering, linear classifiers such as Fisher's linear discriminant and logistic regression, support vector machines, k-nearest neighbor, decision trees, neural networks, Bayesian networks, and Hidden Markov models. These algorithms may be applied to data in the building permit database to serve as training sets to predict the condition risk or underinsurance risk of a particular property.

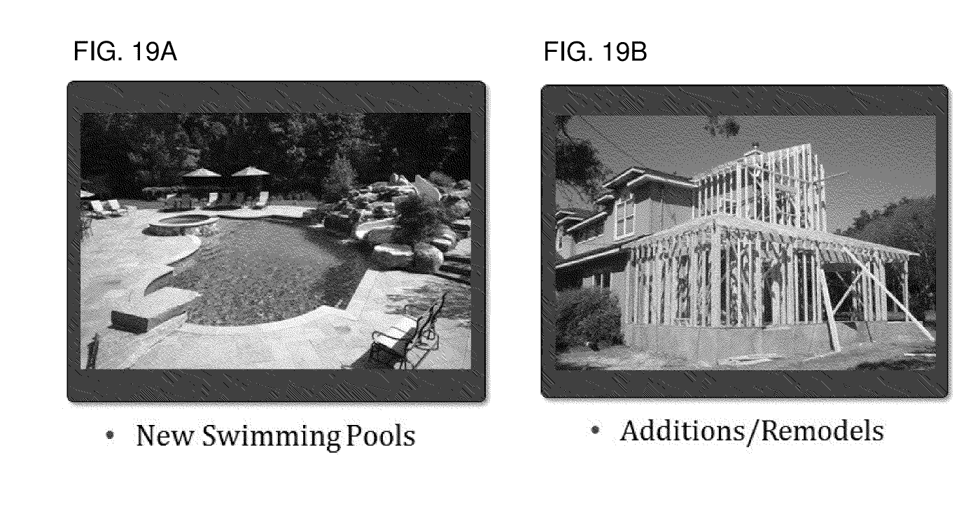

FIGS. 19A-19B show examples of major changes to a property (new swimming pools or additions, respectively) which result in a high probability of underinsurance. Other major changes include remodels such as those discussed previously herein. The value of these changes can be estimated through job cost information associated with the permit. When a permit with a major change is identified, the property is flagged as a High Probability of Underinsurance. A detailed physical inspection can be recommended to appraise the value of the property based on the new addition, and based on the appraised value, a new or modified insurance contract may be underwritten with increased premiums.

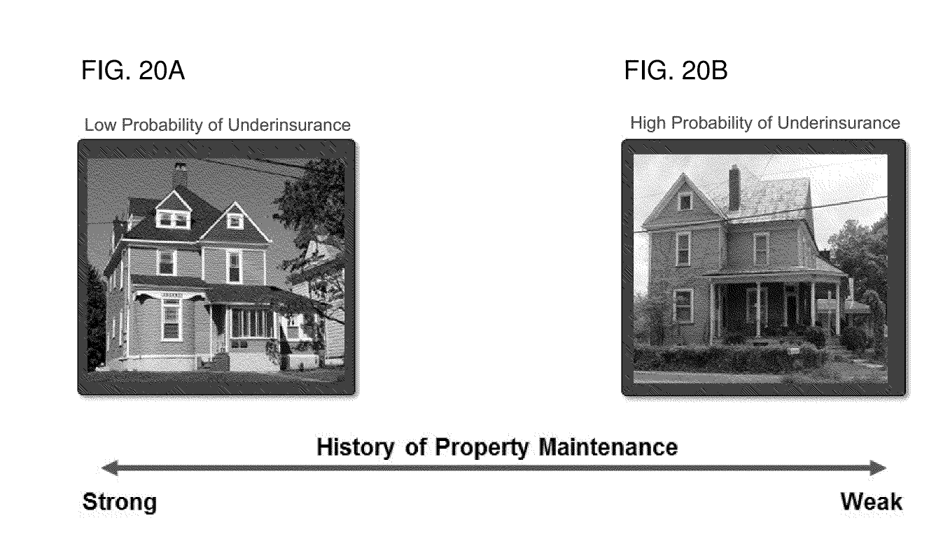

FIGS. 20A-20B show examples of properties with a low condition factor and a high condition factor. The property shown in FIG. 20A is well maintained (including a new roof, siding, recent painting, etc.) and thus has a strong history of property maintenance (shown in building permits and related data) and presents a low condition factor, while the property shown in FIG. 20B has not been well maintained (no improvements in the past 20 years, old roof) and thus has a weak history of property maintenance (as exemplified by lack of building permits) and presents a high condition factor. For properties like that shown in FIG. 20A, categorized as a Low Condition Factor, additional action such as a physical inspection may not be required, or the property could be assessed with a more general, lower cost physical inspection. For properties similar to the property shown in FIG. 20B, flagged as a High Condition Factor, a detailed physical inspection can be recommended to provide an estimate of potential underinsurance the property and a new or modified insurance contract may be underwritten with higher premiums to be commensurate with the property condition.

These property conditions can be characterized through building permits. Benefits of the invention include the ability to isolate actionable underinsurance and make more informed decisions, improve turnaround time and reduce physical inspection spending, and increase premium dollars during re-inspection by determining which properties have had significant changes since the original inspection.

### Computers or Devices

Embodiments of this disclosure include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, operations, algorithms, statistical methods, formulas, or computational routines of this disclosure. The computer or device performing the specified calculations, processes, steps, operations, algorithms, statistical methods, formulas, or computational routines of this disclosure may comprise at least one processing element such as a central processing unit (i.e. processor) and a form of computer-readable memory, such as non-transitory computer readable media, which may include random-access memory (RAM) or read-only memory (ROM). The computer-executable instructions can be embedded in computer hardware or stored in the computer-readable memory such that the computer or device may be directed to perform one or more of the processes and operations depicted and/or described herein.

### Computers Systems

Additional embodiments of this disclosure comprise a computer system for carrying out the computer-implemented method of this disclosure. The computer system may comprise a processor for executing the computer-executable instructions, one or more databases described herein, an input/output interface or user interface, and a set of instructions (e.g. software) for carrying out the method. The computer system can be a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in memory that is operably connected to an internal database. The central computer may perform the computer-implemented method based on input and commands received from remote computers through the internet. The central computer may effectively serve as a server and the remote computers may serve as client computers such that the server-client relationship is established, and the client computers issue queries or receive output from the server over a network.

The input/output interfaces may include a graphical user interface which may be used in conjunction with the computer-executable code and databases. For example, the graphical user interface may allow a user to input a property address, perform a search for the property in the database, display results of permit information of the computer-implemented method of this disclosure in a variety of report formats such as in XML as shown in FIG. 2 or formatted HTML as shown in FIGS. 3-8, or save a PDF file or print a hardcopy of the results. The graphical user interface may allow a user to perform these tasks through the use of text fields, check boxes, pull-downs, command buttons, and the like. The interface may provide access to information in internal databases or include links to external databases. A skilled artisan will appreciate how such graphical features may be implemented for performing the tasks of this disclosure. The user interface may optionally be accessible through a computer connected to the internet. In one embodiment, the user interface is accessible by typing in an internet address through a web browser and logging into a web page. The user interface may then be operated through a remote computer (client computer) accessing the web page and transmitting commands or receiving output from a server through a network connection.

Such graphical controls and components are reusable class files that are delivered with a programming language. For example, pull-down menus may be implemented in an object-oriented programming language wherein the menu and its options can be defined with program code. Further, some programming languages integrated development environments (IDEs) provide for a menu designer, a graphical tool that allows programmers to develop their own menus and menu options. The menu designers provide a series of statements behind the scenes that a programmer could have created on their own. The menu options may then be associated with an event handler code that ties the option to specific functions. Text fields, check boxes, and command buttons may be implemented similarly through the use of code or graphical tools. A skilled artisan can appreciate that the design of such graphical controls and components is routine in the art.

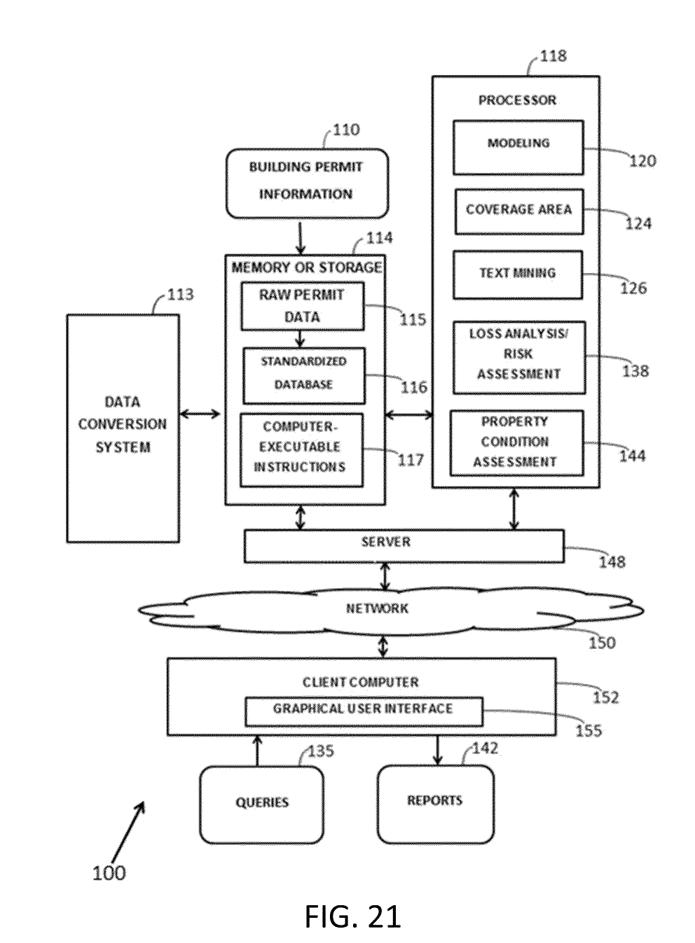

FIG. 21 shows an embodiment of computer system according to this disclosure. The computer system 100 comprises a memory or storage 114 where construction information such as building permit information 110 is saved as raw data 115. A data conversion system 113 converts raw data 115 into a standardized database format 116. The memory or storage also includes a set of computer-executable instructions 117. A processor 118 connected to the memory 114 executes data processing functions according to the computer-executable instructions 117. The data processing functions include for example one or more of modeling 120, calculation of coverage area 124, text mining 126, loss analysis 138, and property condition assessment 144. Processor 118 and memory 114 may be connected to a server 148 with a connection to a network 150, such as the internet. Queries 135 and other inputs are entered into a graphical user interface 155 such as a webpage displayed on a client computer 152 connected to the network 150 and transmitted to the server 148 and reports 142 may be returned from the server 148 to the client computer 152 through the graphical user interface 155.

### Applications

The output of the computer-implemented method can be used in the insurance industry to make specific recommendations for policy implementation and underwriting. For example, the insurance carrier may implement a discount in premiums if the property has had a permit in the last five years, or a surcharge if the property has not had a permit since the initial construction of the property and the property is over a certain age. The following describes specific applications which the present disclosure can be used for.

Applications of the computer-implemented method may utilize a property condition score or may rely on construction information only (such as building permit or related information) without a score. The following applications rely on construction information without a property condition score:

### Automated Appraisal Analysis for Lending

The relationship between permit data and property condition (namely: the presence of recent permits, especially with higher job costs, correlates with better property condition, and also the converse—absence of recent permits correlates with worse property condition) can be applied to analyzing “Property Condition” scores that residential appraisers put into appraisals (from C1 to C6).

For example, this can be used in situations where the subject property and comparable properties are rating low on the condition scale (like C4-C6), but, in reality, the comparable properties are actually in much better condition (like C2). This setup is the easiest way for appraisers today to inflate an appraised value, because their interpretations of comparable property conditions are given a lot more leeway than of the subject property. In this way, building permit data can be used to identify where the comparable properties have recent improvements, but the subject property hasn't had an improvement in years.

### Remodeling Discounts

Insurance companies can use building permit information such as permit age, permit type, job costs as an indicator of which older homes are in better condition and are less likely to have insurance claims, and so they can offer discounts to those customers based upon the information.

### Updating “Year Built”

Insurance companies can also choose to move the “Effective Year Built” date that they use for a particular property forward based upon building permit age information.

### Rating on “Permit Age”

Insurance carriers can use building permit age information to create a profile of a particular set of permits (set of types/job costs/age) and charge different rates depending upon the property's history.

### Inspection Optimization

Many insurance carriers inspect all homes that they insure, or perhaps all homes over a certain age. These inspections can be quite expensive (usually more than $150 per inspection), so it can be helpful for insurance carriers to verify which sets of permits correlate with inspection results of “totally fine”.

Thus, carriers may use building permit information for rating or eligibility and can get most of the benefit by rating/discounting/surcharging on “most recent remodel” or by moving year built forward. “Most recent remodel” is not an arbitrary score—and it doesn't require a proprietary solution as other evidence of “most recent remodel” is available. In contrast, methods relying on a score such as those described in U.S. Pat. Nos. 7,966,203 and 8,027,850 may have difficulty in gaining approval by insurance regulators, who may not accept scores that aren't broken down into specific, actionable, obviously-changeable factors. This is why credit score—even though it is quite predictive of auto loss—can't be used for rating or eligibility in quite a few states. Thus, methods that provide construction information such as building permit information in itself (e.g. number of permits over a time period, permit category, job cost) can provide a significant advantage over methods that provide a score as the former do not face the same regulatory hurdles as the latter.

### Example 1

An Insurance Agent uses a client computer to access a webpage and enters the address of a structure owned by the Insured into an input form. The client computer then sends the query over the internet to a server, which causes a processor and memory to return a report with building permit information associated with the structure including the type of permits, age of permits, and costs of each permitted job to the Agent. The Agent sees a number of permits within the last five years that indicate a number of high-cost remodeling jobs. The Agent uses this information to determine whether a physical inspection and/or an adjustment in insurance coverage is needed to adequately cover the property in light of the upgrades.

### Example 2

An Insurance Underwriter uses a client computer to access a webpage and enters the address of a structure owned by the Insured into an input form. The client computer then sends the query over the internet to a server, which causes a processor and memory to return a report that flags the home as having a High Probability of Underinsurance and includes a recommendation for a detailed physical inspection of the property. The report also includes building permit information which shows that an in-ground pool was installed within the last five years and that installation costs exceeded $20,000. The Underwriter orders a physical inspection of the home to appraise the value, and a new policy is underwritten based on the appraised value.

### Example 3

An Insurance Underwriter uses a client computer to access a webpage and enters the address of a structure owned by the Insured into an input form. The client computer then sends the query over the internet to a server, which causes a processor and memory to return a report that flags the home as having a High Condition Factor and includes a recommendation for a detailed physical inspection of the property. The report also summarizes that the property has no building permits associated with it within the last 10 years. The Underwriter orders a physical inspection of the home to assess the condition, and a new policy is underwritten based on the newly-assessed condition.

The present invention has been described in this disclosure with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. For example, any of the methods described can be implemented in systems according to the invention, while any of the systems described can be configured to operate any of the inventive methods. Additionally, methods and systems of the invention relating to a property with or without a structure are equally applicable to a structure, and methods and systems of the invention relating to a structure are equally applicable to a property with or without a structure. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure including published patents, published patent applications, and non-patent literature are each individually incorporated by reference herein in their entireties and as such are intended to provide an efficient way of supplementing the enabling disclosure of this invention as well as provide background detailing the level of ordinary skill in the art.

1. A method comprising:
searching a database of permit data associated with a plurality of properties;
determining whether permit data for a target property is present in the database;
if the permit data for the target property is present, extracting improvement data or maintenance data associated with the target property from the permit data;
using a computer processor and the presence or lack of permit data associated with the target property, the improvement data, and/or the maintenance data to identify whether physical condition of the target property has changed over time and to estimate an extent to which the physical condition of the target property has changed; and
assigning a score to the target property based on whether and the extent to which the physical condition of the target property has changed.

2. The method of claim 1, wherein the permit data includes one or more of a number of building permits within a particular time frame, building permit age, building permit category, and permitted job cost.

3. The method of claim 2, further comprising data mining of the building permit data for key words to determine one or more categories of building permit data, wherein the score is estimated based on the one or more categories of building permit data associated with the target property.

4. The method claim 2, wherein the building permit category is one or more of building, electrical, mechanical, plumbing, HVAC, pool, roof, foundation, flooring, drywall, frame, window, siding, kitchen, living room, family room, bathroom, bedroom, office, hallway, basement, garage, repair and replace, addition, and remodel.

5. The method of claim 1, wherein the score is selected from the group consisting of Highly Improved Condition, Highly Maintained Condition, Moderately Maintained Condition, Low Maintained Condition, and Not Enough Information on File to Make a Determination.

6. The method of claim 1, further comprising determining whether no inspection, a general inspection, or a detailed inspection of the target property is recommended to confirm the estimated physical condition of the target property.

7. The method of claim 5, wherein the score is determined using the computer processor and involves one or more classification algorithms programmed in computer-readable code for providing a property score of:
(i) excellent, when the number of building permits for the target property in the preceding 2 years is equal to 5 or more;
(ii) above average, when the number of building permits for the target property in the preceding 5 years is at least 1 and the job cost is at least half assessed value of the target property at the time of the permit;
(iii) average, when the number of building permits for the target property in the preceding 10 years is from 2-4 and the job costs aggregated range from $5-20,000;
(iv) below average, when the number of building permits for the target property in the preceding 15 years is less than an average number of building permits for other properties in the same jurisdiction over the same time period; or
(v) poor when the number of building permits for the target property in the preceding 20 years is equal to 0.

8. A system comprising:
a non-transitory computer memory for storing data indicative of:
(i) an expected permit history for a real estate property, wherein the expected permit history includes expected maintenance events for maintaining the real estate property in an acceptable condition,
(ii) events associated with actual maintenance of the property, and
(iii) events associated with actual improvements made to the property,
a processor in communication with the memory, wherein the processor is configured for:
comparing the expected permit history with the events associated with actual maintenance of the property to estimate a physical condition of the property; and
determining whether inspection of the property is needed to confirm the estimated physical condition of the property, wherein the determining is based at least in part on a result of the comparing and the events associated with actual improvements made.

9. The system of claim 8, wherein if no events associated with actual maintenance of the property are present in the memory, inspection of the property is recommended.

10. The system of claim 8, wherein if more events associated with actual maintenance of the property are present in the memory than are indicated by the expected permit history, no inspection of the property is recommended.

11. The system of claim 8, wherein if some events associated with actual maintenance of the property are present in the memory but not as many as are indicated by the expected permit history, inspection of the property is recommended.

12. The system of claim 8, wherein if no events associated with actual improvements made to the property are present in the memory, no inspection is recommended.

13. The system of claim 8, wherein if the events associated with actual improvements made to the property constitute improvements that increase the value of the property less than 10%, then no inspection of the property is recommended.

14. The system of claim 8, wherein if the events associated with actual improvements made to the property constitute improvements that increase the value of the property more than 10%, then inspection of the property is recommended.

15. A computer-implemented method comprising:
identifying a target structure for which a condition estimate is desired;
sending one or more queries from a client computer to a database server to input identifying information of the target structure, which database server comprises construction information associated with identifying information of a plurality of structures including the target structure;
processing construction information associated with the target structure with a computer to estimate physical condition of the target structure; and
returning to a client computer a category chosen from a plurality of categories stored in computer memory to characterize the physical condition of the target structure based on the processing.

16. The method of claim 15, wherein the construction information includes one or more of a number of building permits within a particular time frame, building permit age, building permit category, and permitted job cost.

17. The method claim 16, wherein the building permit category is one or more of building, electrical, mechanical, plumbing, HVAC, pool, roof, foundation, flooring, drywall, frame, window, siding, kitchen, living room, family room, bathroom, bedroom, office, hallway, basement, garage, repair and replace, addition, and remodel.

18. The method of claim 15, wherein the category is selected from the group consisting of Highly Improved Condition, Highly Maintained Condition, Moderately Maintained Condition, Low Maintained Condition, and Not Enough Information on File to Make a Determination.

19. The method of claim 15, further comprising determining whether no inspection, a general inspection, or a detailed inspection of the target structure is recommended.

20. The method of claim 15, wherein the processing involves one or more classification algorithms programmed in computer-readable code and newer permits are given more weight than older permits and:
permits 0-5 years old have a first weight,
permits 6-10 years old have a second weight less than the first weight,
permits 11-15 have a third weight less than the second weight, and
permits 16 years old and greater have the least weight.
